(19) United States
(12) Patent Application Publication
(10) Pub. No.: US 2026/0281544 A1
(43) Pub. Date: Sep. 17, 2026

(54) INTELLIGENT DYNAMIC BITRATE CONFIGURATION IN DAISY CHAINED ETHERNET CAMERAS

(71) Applicant: e-con Systems India Private Limited, Chennai (IN)

(72) Inventors: R. Shanthakumar, Chennai (IN); Arun Muthuganesh, Chennai (IN)

(21) Appl. No.: 19/077,110

(22) Filed: Mar. 12, 2025

(51) Int. Cl. H04N 23/661; H04N 23/90

(52) U.S. Cl. CPC H04N 23/661; H04N 23/90

(57) ABSTRACT

A system of a plurality of ethernet cameras controlled by a microcontroller based computing device having an associated server, each ethernet camera comprises a first ethernet port, a second ethernet port, and an interconnection switch, the interconnection switch selectively transmits the control communication packet received from the first ethernet port to the second ethernet port or to its RTSP server, and transmits the video data and control communication packet received from the second ethernet port to the first ethernet port, the plurality of ethernet cameras electrically and electronically connected in a daisy chain configuration, a system computer program residing in the microcontroller based computing device is configured to dynamically control cumulative bitrate of video communication, within a prescribed bitrate limit, captured by the plurality of ethernet cameras, based on real-time assessment of priority, motion, situation and illumination of each ethernet camera, avoiding network congestion and loss of quality.

### FIELD OF THE INVENTION

The present invention relates to commercial and industrial field ethernet cameras and aims at intelligently adjusting the bandwidth for each camera in a daisy chained network based on the scene and detection of motion. Particularly, the most important feature of this invention is the bitrate calculation to maintain the quality of the scene in the allocated bandwidth.

### BACKGROUND OF THE INVENTION

Daisy chaining Ethernet cameras is a technique of connecting multiple devices in a series using an Ethernet cable. Daisy chained cameras shares the available bandwidth in the network. Variable bitrate (VBR) is a method of controlling the bitrate of a video stream in an IP camera. Variable bitrate is specific to a single camera and each camera in Daisy chain sets it bitrate independently. This intelligent bitrate control can be applied to all the applications which uses daisy chained ethernet cameras.

GB2595887A discloses a method for transmitting media data in a network with devices connected in cascade involves timing media data capture, forwarding packets between devices, and determining transmission delays. If a delay is detected, the device transmits local media data. This method ensures efficient use of bandwidth, especially in systems with multiple sensors or cameras, by coordinating data transmission and handling variable bit rates within allocated time slots.

US20220303596A1 teaches a system and method for reducing bandwidth in media broadcast production. The system comprises multiple content-providing devices, each equipped with a variable compression. A remote production system manages these compressions, directing them to use either high-fidelity or compressed encoding methods. The system ensures that the media feed included in the final production is encoded with high fidelity, while other media streams are compressed to conserve bandwidth.

U.S. Pat. No. 10,574,996B2 teaches a method controls a video compression's output bitrate by setting a long-term bit budget and determining allowable bitrates based on this budget and instantaneous restrictions. The bitrate is managed to comply with both long-term and immediate constraints. This method can be implemented via software or a bitrate controller in devices like cameras and network video recorders.

US20100111180A1 teaches a method and apparatus for scene change detection in video compression adjust the bit-rate by analyzing complexity data from partially compressed pictures.

US20180352175 describes a near-infrared sensitive video camera with a control unit that dynamically detects camera settings such as zoom, focus, and IR-illuminator status. It then acquires a corresponding gain setting map from a database, which includes specific gain settings for the image sensor based on these detected settings. The control unit dynamically adjusts the image sensor's gain settings according to the acquired map to optimize the camera's performance.

Some of the above discussed solutions deploy a daisy chain network cameras but uses controlled bitrate or constant bitrate where the maximum bitrate limit is not adjusted for the individual cameras depending on the specific scene.

Importantly, none of the prior art address adjusting the network bitrate which depends upon the individual camera scene and detection of motion while each doing the compression. In video compression protocols, such as H.264, the bitrate is minimum when the scene is static, and the bitrate is maximum when the scene has more changes compared to the previous scene.

### SUMMARY OF INVENTION

The present invention is a system of a plurality of ethernet cameras controlled by a computer or a personal computer (PC) with an associated server, hereinafter termed as a server, wherein the plurality of ethernet cameras are electrically and electronically connected in a series configuration, generally termed as a daisy chain. The system is an invention of intelligent dynamic bitrate configuration in such daisy chained ethernet cameras. One of the primary advantages of daisy chaining is the reduction in cabling. The challenges associated with such series configuration are addressed as well in the present invention. The plurality of ethernet cameras send video data, receive electrical power, send and receive control signals through such serial configuration. Independent of the number of nodes, the communication is always injected at only one port.

Electric Power to drive the system is connected through ethernet cable wherein the power is supplied from the server of the server PC to the “Power on Ethernet” (PoE) module of respective Ethernet cameras. The electrical power through serial communication can cause disruption consequent to serial overcurrent protections provided. Such disruption is avoided by introducing a faster branched overcurrent protection of less than 1×A milliamperes in each branch. The graded as well as branched overcurrent protection is in the form of a hard wired fuse or over current protection or an e-fuse.

The present invention recognizes that daisy chain, like any serial chain, simplest being a mechanical chain of links, is as strong as the weakest list. Daisy chain of the present invention addresses several electrical and electromechanical serial links, to be able to fully exploit the cost advantages associated with serially connected ethernet cameras.

In the preferred embodiment, following one or more of the following is incorporated:
A closed loop signal feedback keeping a watch on mechanical engagement of serial connectors. Any loose connections would cause a change in the closed loop signal.
A path impedance feedback keeping a watch on mechanical engagement of serial connectors. An unusual change in path impedance would imply mechanical weakness/rupture.

Each ethernet camera comprises at least two ethernet ports-termed a first ethernet port and a second ethernet port, and an interconnection switch. The ethernet camera is equipped with an infra-red light source preferably a light emitting diode, abbreviated as IR LED, along with an infra-red cut filter, facilitating a lens and an image sensor to capture images or videos. A “Power on Ethernet” (PoE) module is provided. As a variation, the IR LED is external to the ethernet camera. An Image Signal Processors (ISP) and a compression unit and a neural processing engine (NPU) are executing hardware components of each ethernet camera. The ISP is responsible for processing raw image data captured by the camera's image sensor. It handles tasks such as colour correction, noise reduction, exposure control, and image sharpening. The ISP ensures that the image quality is optimized before it is encoded and transmitted.

The interconnection switch connects the second ethernet port to the first ethernet port when the ethernet cameras are connected in a series configuration.

Each ethernet camera transmits a captured video data from its first ethernet port to the second ethernet port of next Ethernet camera in the serial connection towards the server PC, until the video data reaches the server PC through in-between interconnection switch of each ethernet camera, consequently the first ethernet port of each camera transmits its own video feed and also forwards the video data from previous cameras to the server PC, wherein the closer to the server PC the ethernet camera is, the more video data its first ethernet port, its second ethernet port and its interconnection switch handles, as it transmits its own video data as well as the video data of all preceding ethernet cameras.

A system computer program resides in a non-volatile memory of the server of the server PC, and communicates with a camera computer program that resides in a camera memory. The system computer program is configured to:
Requisition a prevailing bit rate from each of the ethernet camera of the plurality of connected ethernet cameras.
Send an acknowledgement of the receipt of the prevailing bitrate to each of the ethernet cameras of the plurality of connected ethernet cameras.
Set dynamically an updated and balanced bit rate of each of the ethernet cameras of the plurality of connected ethernet cameras.
Receive dynamically the updated and balanced bit rate of each of the ethernet camera of the plurality of connected ethernet cameras.
Receive a motion detection notification from any of the plurality of ethernet cameras.
Send acknowledgement of a corresponding motion detection notification.
Register day and night mode change of any or each ethernet cameras.
Acknowledge day and night mode change of corresponding ethernet cameras/

Each to and fro communication including RTSP video data, RTSP commands from/to server PC to/from ethernet camera is on daisy chained network through the ethernet cable and provided with a corresponding address bit for appropriate delivery and receipt. Effectively, a direct logical connection happens from server PC to each ethernet camera, therefore the RTSP setup commands are sent directly to each camera from server PC and not through camera to camera, though electronically the commands and data moves between ethernet ports through respective interconnection switches.

In the daisy-chained camera network as per present invention, each control message includes a checksum, which is calculated and appended before transmission. Upon receiving the control message, the receiver verifies the checksum to ensure data integrity and detect any errors that may have occurred during transmission. This mechanism enhances the reliability and robustness of the communication process within the network. The system computer program periodically broadcasts a specific, one-to-one control messages to all connected ethernet cameras to monitor their status. Each ethernet camera is expected to respond to the broadcast within a predefined timeout period by the system computer program. If any ethernet camera fails to respond, it indicates a potential issue with that specific camera. The host identifies the problematic camera based on the lack of response and promptly notifies the user, enabling quick detection and resolution of any issues.

The Image signal processor (ISP) of each of the Ethernet camera, besides converting each image or frame from its raw form to a usable form with correction of usability parameters including colour, contrast, brightness, gain and exposure, day and night detection; carries out an important functions of detection of motion. Scenes with motion are captured by Ethernet camera with higher number of frames per unit time, requiring higher bitrate to communicate the video. All cameras in the series connection collective have an upper limit of availability of bitrate.

The ISP as per present invention detects rate of change of motion as acceleration and as deceleration, sudden start and stop of motion. A neural processing engine processes such input of ISP and with the aid of situational machine learnable data ascertains priority images or frames. The neural processing engine of the present invention also ascertains priority images or frames irrespective and independent of detection of motion. This function is further explained with illustration.

A compression unit of each ethernet camera receives instruction directly from the ISP or through neural processing engine to compress a video by dropping insignificant or nearly repeated frames. The compression unit of the present invention also receives instruction directly from the ISP or through neural processing engine to decompress a video and improve the video quality of priority frames, as explained later.

A bitrate manoeuvre subroutine of the system computer program keeps a control on bitrate in use and unused bitrate and the system computer program communicates permissible bitrate to respective Ethernet camera. The bitrate manoeuvre subroutine, based on priority frames ascertainment by the neural processing engine instructs the prescribed ethernet camera to increase bitrate of static frames, as further elaborated with illustration.

Thus, the system of the plurality of ethernet cameras connected in daisy chained network configuration aims at intelligently adjusting the bandwidth allocation for each camera based on real-time priority based scene analysis and motion detection such that each camera efficiently uses the available network bandwidth without causing network congestion and loss of quality.

The present invention recognizes that at times, bitrate requirement of camera may increase for reasons other than due to motion or priority allocation and the invention addresses the reason. One such reason addressed by the present invention is a bit rate rise due to gain rise. The present invention monitors gain of each camera along with its bitrate. The gain and bitrate change in a definite relation is inferred as consequent to reasons other than motion or prioritization.

Particularly, a gain and bitrate change in the definite relation triggers a check of day or night change or change in lighting conditions. The system enables an infra-red (IR) light illumination and a simultaneous deactivation of IR cut filter. The net bitrate rise still found is only accounted for and used in bitrate re-allocation.

The preferred embodiment of the present invention envisages an IR light emitting diode integral to the ethernet camera, however IR light can also be external to the camera and of requisite intensity.

The architecture involves multiple Ethernet cameras connected in a daisy-chained network, with the entire network of cameras further connected to a system server. In a daisy-chained network, each camera is connected to the next in a linear sequence. The first camera in the chain is connected directly to the network or server PC, and each subsequent camera is connected to the previous one. This forms a chain-like structure, where data from each camera is passed along the chain until it reaches the server PC.

When any camera captures video data, it transmits this data to the next camera in the chain towards the server PC. This process continues until the data sequentially reaches the server PC through the third, second, first camera respectively. Each camera in the chain not only captures and transmits its own video feed but also forwards the data from previous cameras in the chain. Because the cameras share a common network path, the available bandwidth must be managed carefully. The closer to the server PC a camera is, the more data it has to handle, as it must transmit its own data as well as the data from all preceding cameras.

Such serial connection therefore mandatorily pushes for and makes efficient bandwidth management critical, especially in scenarios with high-resolution video feeds and or with high numbers of cameras.

In a daisy-chain camera setup that necessitates multiplexing and packetizing multimedia transport streams, a Real-Time Streaming Protocol (RTSP) is deployed which enables real-time video transmission from a network of serially connected cameras by setting up and controlling the data stream between the plurality of cameras and server PC. RTSP issues commands to establish a streaming session between the server PC and the plurality of daisy-chained cameras. The server PC sends an RTSP SETUP command to initiate the session with a first connected camera. The SETUP command designates the type of media stream, transport protocol, and network ports for data. Importantly, the transmission of streaming data itself is not a task of RTSP. Most RTSP servers use the Real-time Transport Protocol (RTP) in conjunction with Real-time Control Protocol (RTCP) for media stream delivery. As a variation, proprietary transport protocols may be deployed. The RTSP server software from RealNetworks, for example, also uses RealNetworks' proprietary Real Data Transport (RDT).

Further cameras then receive commands in sequence as the control data moves from ethernet port two of the first ethernet camera through the interconnection switch of the first ethernet camera to ethernet port one of the next camera through the interconnection switch of the next camera in a definite though infinitesimally small time, and so on; with each camera likewise configured to forward streams to the camera closer to the server PC and eventually to the server PC, creating a controlled daisy-chain stream. Once the system is set up, RTSP initiates RTP streams to transmit video packets from each camera in the chain. RTP handles the real-time transport of video data, breaking it into packets and managing timing to synchronize video and audio.

Each camera is equipped with a microcontroller generally known as a “system on chip”, also known as SoC.

A daisy chain as described above has an unused second ethernet port of the farthest camera. In order to add reliability to the daisy chained cameras with the unused second ethernet port, it is prudent to connect the second ethernet port to the server PC and thereby provide an alternate serial connection. The alternate serial connection (240) is deployable in several ways, and two such variations are disclosed below.

In a variation, the alternate connection is activated from the server PC in the event that one or more cameras are detected to be not responding.

In another variation, the alternate connection is activated for bitrate balancing by dividing the number of connected ethernet cameras in two prescribed groups based on bitrate history as per application. Illustratively, in a chain of 7 cameras, camera 1 to 5 may communicate through a first serial connection and camera 6 and 7 may communicate through the alternate connection if camera 6 or 7 or both require higher bit rate than camera 1-5.

It is previously summarily discussed that motion results in higher bandwidth requirement from a camera. The present invention also recognizes the situations that more than one or all cameras in a series configuration capture motion of similar order and cumulative bandwidth requirement exceeds pre-decided system bandwidth. Present invention also recognizes the situations that cameras capturing static or low movement frames may also require high quality video for analysis and decision making.

In an embodiment, the ISP identifies an area of interest in each frame based on detection of motion and scene information. The area of interest around an object position comprises blocks of frame which are smaller, non-overlapping clusters of N×N pixels, for example, 16×16 or 32×32 pixels. These blocks form minimal sample units for motion as well as scene analysis. The preceding or previous frame from the video sequence is also divided into the same block sizes for comparison. Block-based division simplifies the computational problem by limiting motion analysis to manageable regions. For each block in the current frame, the area of interest is defined in the previous frame around the block's original position.

An algorithm compares current block(s) to blocks in the area of interest in previous frame. The area of interest specifies the region where the matching block is likely to be found, based on expected movement (e.g., a car might move within a 20-pixel radius). The algorithm selects the block with the smallest pixel value difference as the best match, and its displacement generates a motion vector. The size of area of interest is a prescribed linear equation, illustratively (2W+1)×(2W+1), where W, an area of interest parameter, is maximum expected unit displacement, configured specific to application. For example, if W=10, the area of interest is 21×21 pixels, meaning the algorithm searches within approximately 10 pixels in all directions. The area of interest size may be dynamically adjusted based on scene complexity to balance computational cost and accuracy. The ISP dynamically adjusts the area of interest parameter (W) and prioritizes blocks based on the objects identified based on a library of objects for example human faces or vehicles or buildings or other stray objects. The system server may store video data locally on hard drives or network-attached storage (NAS) devices, or it could send the data to cloud storage for long-term archiving.

For each block in the current frame, the algorithm searches for the best-matched block within the area of interest in the previous frame. The similarity between blocks is quantified using error metrics such as Sum of Absolute Differences (SAD), Mean Squared Error (MSE), etc. The block in previous frame with the lowest error is considered the best match for the current block. The Motion Vector (MV) represents the displacement between the best-matched block in previous frame and the corresponding block in current frame. For each block, compute the magnitude of the motion vector (MV) derived from the difference between the current and previous frames:

$$Magnitude = \sqrt{{( {x}_{c urrent} - {x}_{p r e v} )}^{2} - {( {y}_{c urrent} - {y}_{p r e v} )}^{2}}$$

Here, x_{current}, y_{current}, xₚᵣₑᵥ, yₚᵣₑᵥ are the coordinates of the block in the current and previous frames, respectively. MV represents the displacement of the block.

Cameras can perform onboard analysis of the captured scenes to identify important events, such as motion or security breaches. Only critical video data is streamed in full resolution or at higher priority, while less critical data is forwarded with lower resolution or even dropped if bandwidth is insufficient. When events in specific scenes are not flagged as high-priority, cameras may send metadata or reduced-quality versions of the feed to lessen bandwidth consumption. This is particularly effective in cases where continuous high-resolution video is unnecessary.

With a Neural Processing Engine (NPE), each camera can perform complex video analytics locally including event classification and prioritization besides object detection, motion recognition. Instead of sending the full video feed, the camera can transmit only key data summaries or specific event clips, reducing the data load on the network.

The neural processing engine provides adaptive thresholds by learning from various environmental factors and motion characteristics. There are various key factors considered for threshold decision such as scene type as indoor, outdoor, crowded, lighting or weather, etc.

ISP with or without machine learning continuously monitors motion vector distributions across blocks. If the magnitude of MV is less than a predefined threshold, classify the block as static:
If Magnitude<Threshold, then Static Region.

Dynamic regions are blocks where significant motion is detected. These areas are often of higher interest for events, objects, or actions

If the magnitude of MV is greater than or equal to the threshold, classify the block as dynamic:
If Magnitude>Threshold, then Dynamic Region.

Machine Learning models trained on diverse datasets predict optimal thresholds dynamically:
1. Training dataset which includes samples of frames labelled with static and dynamic regions across different environments.
2. Features for Prediction:

Average motion magnitude in the frame.

Histogram of motion magnitudes across blocks.

Contextual scene features (e.g., crowdedness, presence of moving objects).
3. Model Output: AI predicts a threshold value specific to the current scene.

The ISP with or without machine learning identifies blocks with motion as active or areas of interest. This block-based approach allows for focused monitoring within certain regions, reducing unnecessary data processing for static blocks (areas with no detected motion). If motion is detected in a block, the camera increases the bitrate for that block's data, allowing it to capture and transmit higher-quality details for the moving object or event. Bulk of blocks without detected motion can be transmitted at a lower bitrate.

The preferred compression unit compresses the processed video data into a format that can be efficiently transmitted over the network. H.264 is a widely used video compression standard that reduces the amount of data required to represent video without significantly compromising quality. The present invention is, however, not limited thereto and is configurable with and for different encoding methods including H.265+, H.264+, JPEG, and MJPEG.

The compression unit supports constant bitrate as well as variable bitrate control, allowing it to adjust the bitrate based on the complexity of the scene and the level of motion detected. The bitrate can be increased for high-motion scenes to preserve detail or decreased when the scene is static to save bandwidth. The compression interfaces with both the ISP (for input data) and the network interface controller (for output data).

The ISP in each of the plurality of ethernet cameras analyses the video streams received from each camera. It identifies motion within the scenes and distinguishes between significant motion (e.g., a person or vehicle) and irrelevant changes (e.g., shadows or lighting changes). The ISP may utilize dedicated hardware accelerators, such as GPUs or specialized motion detection processors, to perform real-time analysis on multiple video streams simultaneously. The ISP receives video streams from the cameras via the server's network interface and processes them in parallel.

The bitrate manoeuvre sub-routine is responsible for adjusting the bitrate of each camera's video stream based on the motion analysis results. If significant motion is detected, the bitrate for that camera is increased to improve image quality. Conversely, if no motion is detected, the bitrate is reduced to conserve bandwidth. The bitrate manoeuvre sub-routine makes real-time adjustments by communicating with the cameras over the network, instructing their compressions unit to modify the output bitrate.

The neural processing engine aggregates data from all cameras, including video streams, motion detection results, and current bitrate settings. The server PC invokes AI algorithms residing in the neural processing engine to analyse this data to optimize bitrate allocation across the entire camera network. The NPE can predict future bandwidth needs based on patterns detected in the data, such as peak activity periods or recurring motion events.

The server PC continuously monitors all camera streams and dynamically adjusts bitrates as scene conditions change, ensuring optimal network performance and video quality.

The process for dynamically adjusting the bitrate of Ethernet cameras in a daisy-chained network is based on scene changes and available bandwidth. In the initial step of the process, where the system begins its operation, all components of the camera network, including the ethernet cameras, Image Signal Processors (ISP), compression unit, and the server PC, are powered on by a “Power on Ethernet” (PoE) Module and ready to operate.

In next step of the process, the camera network is configured, and the ISPs within each camera are initialized. During this step:
The cameras establish connections with each other in a daisy-chain configuration,
The ISP begins processing raw image data from the camera sensors, optimizing it for encoding;
to ensure that all cameras are correctly connected, and their ISPs are functioning, ready to detect any changes in the scene.

The ISP in each camera continuously monitors the video feed for changes in the scene. Scene changes could include motion, lighting variations, or other relevant visual alterations. Decision point is the next step involves in the process, where if a change in the scene is detected, the workflow proceeds to the next step and if no change is detected, the system returns to the start of the detection loop, continuously monitoring for changes. To identify when a significant event occurs in the camera's field of view that may require a bit rate adjustment to maintain video quality.

If a scene change is detected, the camera adjusts the bitrate of its compression unit. The bitrate is increased if the scene change involves significant motion or complexity, ensuring the video quality remains high. To dynamically allocate more bandwidth to cameras that are capturing more complex scenes, thereby maintaining image quality without wasting bandwidth on static scenes.

The camera sends data about the scene (e.g., motion level, complexity) to the server PC. This data is crucial for the server to make informed decisions about bandwidth allocation. To provide the server PC with the necessary information to analyze overall network bandwidth usage and make adjustments across the entire camera network.

The neural processing engine continuously receives scene data from each camera. It uses machine learning models to detect significant changes in the scene, such as movement, lighting alterations, or the appearance of new objects. The NPE predicts potential scene changes based on historical data and environmental factors, making the system more proactive rather than just reactive.

Based on the analysis, the server PC allocates the appropriate amount of bandwidth to each camera. Cameras with more complex scenes receive more bandwidth, while others may have their bandwidth reduced. To ensure that each camera operates optimally within the available network bandwidth, maximizing video quality and minimizing the risk of congestion.

The server PC, based on analyses from ISP and neural processing engine allocates bandwidth to each camera based on real-time scene analysis and motion detection respectively. Cameras capturing high-motion scenes receive more bandwidth, while those with static scenes receive less. The server PC prioritizes bandwidth allocation based on the importance of each scene. For example, a camera monitoring a critical area might be given more bandwidth even if the scene is static, ensuring that quality is maintained for high-priority locations.

The server PC checks if the total available network bandwidth is sufficient to support the current bitrate settings for all cameras. The server PC continuously monitors the network's bandwidth usage and determines if the current allocation is sustainable. If the bandwidth is sufficient, the server PC maintains the current settings. If not, it triggers corrective actions to optimize the usage and the system returns to monitoring for scene changes.

The ISP identifies cameras with static or low-motion scenes and reduces their bitrate to free up bandwidth for more demanding cameras. In some cases, ISP can selectively mask certain areas of a static scene, reducing the bitrate without compromising the quality of critical areas within the same frame and the server PC takes further action to reduce the bitrate of cameras capturing static scenes. To prevent network overload by ensuring that the combined bitrate of all cameras does not exceed the network's capacity.

If the network is nearing its bandwidth limit, the server PC reduces the bitrate of cameras that are capturing static or less complex scenes. This frees up bandwidth for cameras that require it due to high motion or complexity. To optimize the use of available network resources, ensuring that critical scenes are captured in high quality while less important scenes are downscaled to preserve bandwidth.

After making any necessary adjustments, the system returns to the initial step of monitoring for scene changes. To continuously and dynamically manage the network's bandwidth and camera bitrate, ensuring that the system remains responsive to changes in the environment. The server PC along with ISP ensures that the system remains in a loop, constantly monitoring scene changes and adjusting bitrates as needed. Over time, the NPE learns from the data it processes, improving its ability to predict scene changes.

The management of video data transmission in the network of cameras uses dynamic bitrate adjustments, area of interest (AOI), masking area of non-interest (AONI), and real-time monitoring to ensure optimal use of bandwidth while maintaining video quality. Cameras are powered on by the PoE module, the network is configured, and initial settings are loaded. The system is ready to begin monitoring scenes and managing the bitrate accordingly. If AI is integrated, it starts by loading pre-trained models, setting up initial parameters, and preparing to analyze incoming data.

The next step of the process is to monitor scene (308) and detect motion. Each camera in the network continuously monitors its assigned scene. The image signal processor (ISP) in each camera analyzes the scene to detect any motion. The system identifies changes in the scene, such as objects moving or lighting conditions shifting. If motion is detected, this triggers further analysis. AI algorithms can enhance motion detection by distinguishing between significant motion (e.g., a person moving) and irrelevant changes (e.g., leaves blowing in the wind). This reduces false positives and ensures that bitrate adjustments are made only when necessary.

Apply masking Area of NON-Interest (AONI) is next step involves in the process. Once motion is detected, the system identifies and segregates from the AONI the specific areas of the scene where the relevant motion occurs. These areas are marked as the “area of interest” (AOI). The system focuses on these AOIs for higher quality encoding, while less important parts of the scene receive lower attention. This helps in optimizing the use of bandwidth.

Based on the detected motion and the defined AOIs and AONIs, the system calculates the required bitrate for each camera. Cameras with more complex scenes (e.g., multiple AOIs or high motion) are allocated a higher bitrate. The system adjusts the bitrate in real-time, ensuring that cameras capturing more important or complex scenes have the necessary bandwidth to maintain video quality. AI models predict the optimal bitrate needed for each scene, taking into account factors like motion complexity, scene lighting, and historical data.

The system checks the total available bandwidth on the network to ensure that the calculated bitrates can be accommodated without causing congestion. If the total required bitrate exceeds the available bandwidth, the system must make adjustments to prevent network overload.

If there's insufficient bandwidth, the system redistributes the bitrate among the cameras. It reduces the bitrate for cameras with static or less important scenes to free up bandwidth for those with significant motion or critical AOIs. The system ensures that the overall network remains balanced, with no single camera consuming an excessive amount of bandwidth. Machine learning algorithms of NPE optimize this redistribution by analyzing which cameras can afford a reduction in bitrate without compromising essential video quality. The NPE can also suggest alternative strategies, such as temporarily lowering the resolution or frame rate.

With the bitrate adjusted and optimized, the cameras transmit the video data to the server PC. The server PC continuously monitors the quality of the transmitted video, detecting any potential issues (like packet loss or jitter) and making real-time adjustments to mitigate them. The process reaches its endpoint, either after a predetermined period or when the system is shut down. The system can also reinitialize for another round of monitoring and adjustment if required.

The system checks whether the gain level in any camera has increased. An increase in gain typically happens when the lighting conditions worsen, such as during night-time or in poorly lit areas. When the gain increases, the system enables Infrared (IR) illumination and deactivates the IR cut filter in the affected cameras. This adjustment helps to improve image quality in low-light conditions without unnecessarily increasing the bitrate. If no gain increase is detected, the system continues to monitor the bitrate and gain levels of each camera, ensuring that they remain optimal for the current scene conditions.

Implementing infrared (IR) illumination and disabling the IR cut filter switch allows IR light to enter the image sensor. IR illumination helps to reduce noise in low-light conditions, thereby providing clearer images without requiring an increase in bitrate. This ensures efficient use of bandwidth by transmitting higher quality images without unnecessary increments.

By processing frames in this manner, we ensure that the bitrate is only increased when it genuinely contributes to image quality improvement. This approach helps manage bandwidth more effectively, especially in challenging low-light scenarios where noise can otherwise lead to inefficient bitrate and bandwidth usage. The number of cameras that can be connected in a daisy chain network depends on the available bandwidth and power consumption of each camera.

This dynamic adjustment ensures optimal use of the available bandwidth, maintaining high image quality where needed while balancing the overall network load.

When all the cameras in the network are capturing scenes with significant motion or changes simultaneously, the system must allocate bandwidth equally across all cameras. This scenario can occur, for example, in a situation where multiple cameras are monitoring different areas of a high-activity environment (e.g., a busy factory floor or a crowded event)

Because the system has to share the available bandwidth among all cameras each camera may receive a lower bitrate than it would if only one or a few cameras were detecting motion. This compromise means that while all cameras can continue capturing video, the quality may be reduced because the available bandwidth must be divided equally. This can lead to a scenario where no single camera can capture a particularly high-quality image, as all cameras are limited by the shared bandwidth. This is a trade-off between ensuring continuous coverage and maintaining the highest possible image quality.

As a variation, an upper prescribed limit for identified cameras is higher than remaining cameras. As a further variation, based on application, there are graded upper and lower prescribed bitrate limits. Illustratively, for a system with 100 MBPS as collective prescribed limit, the graded prescribed limits are:

| Camera Number | Upper prescribed limit | Lower prescribed limit |
|---|---|---|
| 1 | 80 MBPS | 40 MBPS |
| 2 | 70 MBPS | 30 MBPS |
| 3 | 60 MBPS | 20 MBPS |
| 4 | 50 MBPS | 10 MBPS |
| 5 | 40 MBPS | 10 MBPS |

The system requires continuous monitoring of the bitrate of each camera to make real-time adjustments. This monitoring is crucial for maintaining optimal video quality and network performance, especially in dynamic environments where scenes are constantly changing. To achieve this, an external application must be running either on a host PC or on one of the cameras in the network. This application is responsible for continuously analyzing the bitrate requirements of each camera and adjusting them as necessary.

Summarily, the system computer program residing in the microcontroller based computing device and a camera computer program residing in each of the plurality of ethernet cameras (130) execute a dynamic bitrate configuration, comprising the steps of:
a. switching on an electric power to the plurality of ethernet camera in the series configuration
b. setting an upper bitrate and a lower bitrate of each ethernet camera
c. detecting motion in an area of interest of respective ethernet cameras
d. detecting a priority situation with respect to a library of situations and a training data
e. changing permissible bitrate of each camera in direct accordance with motion detection provided a collective bitrate is within a prescribed bitrate limit
f. switching on infra-red illumination (337) and disabling infra-red cut filter to bring the collective bitrate withing a prescribed limit
g. changing permissible bitrate of each camera in direct accordance with priority detection provided a collective bitrate is within a prescribed limit

The present invention, therefore, dynamically manages bitrate configuration in daisy chained ethernet cameras based on motion and priority classification, such that video frames of each ethernet camera are of higher intellect value than just visual contents with minimum or optimum bitrate.

### BRIEF DESCRIPTION OF DRAWINGS

FIG. 1 is a representative diagram of a system of a daisy chained ethernet cameras communicating with server as per present invention.

FIG. 2 is circuit diagram of overcurrent protection of electric power for daisy chained ethernet cameras as per present invention.

FIG. 3 is block diagram of a daisy chained ethernet camera as per present invention.

FIG. 4 is block diagram of a server PC in communication with a first daisy chained ethernet camera.

FIG. 5 is a block diagram of ethernet connection between a plurality of daisy chained ethernet cameras and the server PC.

FIG. 6 is a schematic of daisy chained ethernet cameras with an alternate serial connection.

FIG. 7 is a flow diagram related to the alternate serial connection.

FIG. 8A-8C is a flow diagram of the process steps of the system.

FIG. 9 is a flow diagram related to a critical data.

FIG. 10-11 are a graphical representation of block and area of interest.

FIG. 12-19 represent scenes and situations.

FIG. 20 is a graphical representation of critical scenes and situations.

### DETAILED DESCRIPTION OF THE INVENTION

The present invention shall now be described with the help of accompanying drawings. It is to be expressly understood that several variations are possible around the inventive concept disclosed and the description should not be construed to limit the invention in any manner whatsoever except by the claims which follow.

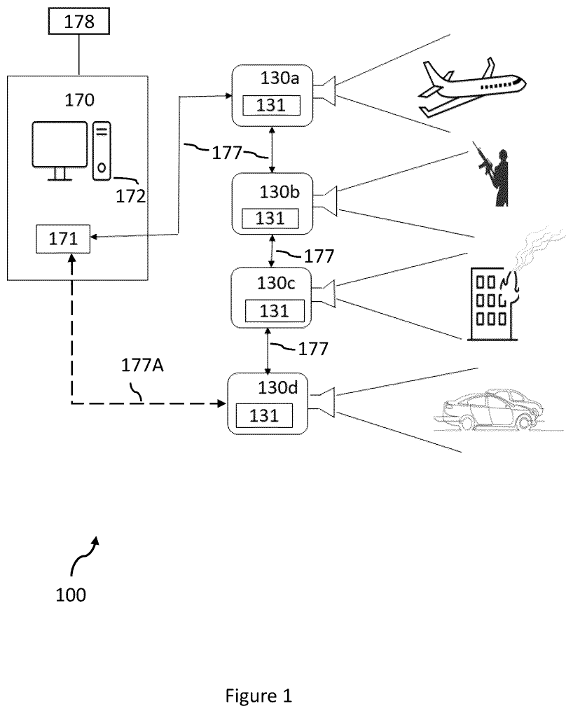

FIG. 1, the present invention is a system (100) of a plurality of distributed ethernet cameras (130a, 130b, 130c, 130d, . . . ) controlled by a controller, computer or a personal computer (PC) with an associated server termed hereinafter as a system server (172), the computer of the personal computer (PC) hereinafter termed as a server PC (170). The plurality of ethernet cameras (130a, 130b, 130c, 130d . . . 130e) are electrically and electronically connected in a series configuration, generally termed as a “daisy chain” (177). The system (100) is an invention of intelligent dynamic bitrate configuration in such daisy chained ethernet cameras (130).

One of the primary advantages of daisy chaining is the reduction in cabling. Instead of each ethernet camera (130) requiring a direct connection to the server PC (170), they share a single network path (177), FIG. 1, reducing the complexity and cost of cabling. The challenges associated with such series configuration are addressed as well in the present invention.

The plurality of ethernet cameras (130) send video data, receive electrical power, send and receive control signals through such serial configuration. Independent of the number of devices or nodes, here cameras (130), the communication is always injected at only one port. In the daisy-chain topology, each node adds latency or queueing time. Therefore, the last node in the series configuration has the longest latency or queueing time between node and host, here server PC (170). In real terms, such latency is of the order of microseconds and therefore of insignificant impact in most such applications as the present invention. In a real-time Ethernet, the protocol of the cameras (130) and server PC (170) must take care of this extra latency, where it matters. The protocol can, for example, send the packet for the last node as the first packet within the cycle. The system (100) then only needs to ensure that the longest latency fits into an acceptable cycle time specific to application. Such protocol may be considered oversimplifiedly analogous to boarding sequence in a huge aircraft, wherein passengers who are allotted seats in the last rows of the aircraft are made to board first!

A short latency adder per node is key for such a system to support many nodes. Illustratively, when the MAC is implemented with a device member of the Texas Instruments Sitara™ MPU family, the adder is only 320 ns. This is a 5% adder per node to the minimum time of 6.7 μs for a 64-byte packet including a 12-byte, inter-packet gap and 8-byte synchronisation.

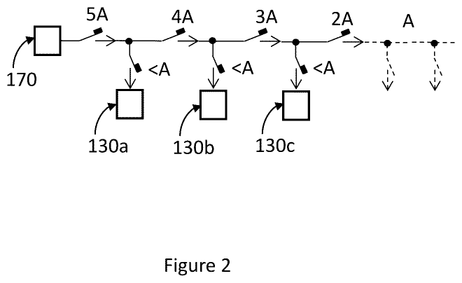

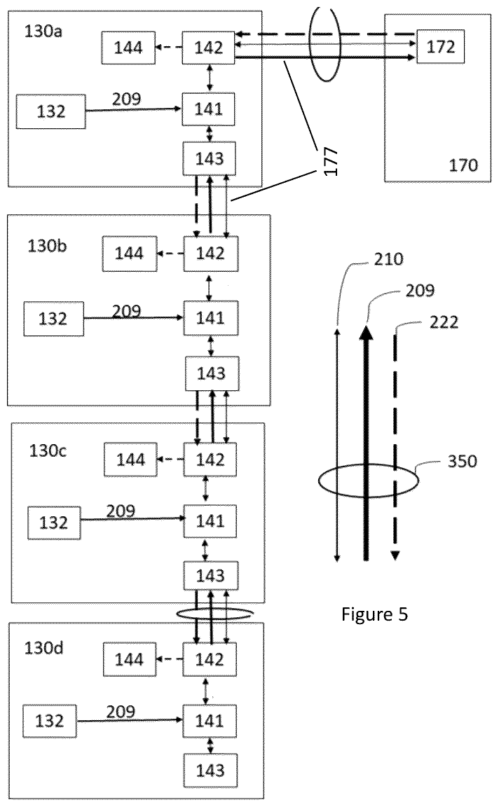

Electric Power (222) (see FIG. 5) or power to drive the system is connected through a physical ethernet cable (350) wherein the power is supplied from the server of the server PC (170) to the “Power on Ethernet” (PoE) module (144) of respective Ethernet cameras (130). FIG. 2, electrical power (222) through serial communication, though a significant cable cost saving, can cause disruption consequent to serial overcurrent protections provided. In a daisy chain of nodes, each node comprising an ethernet camera, draws an electric current of say “A” milliamperes, then simplistically, about 5×A is drawn from an electric power supply of the server PC (170) from all the nodes, here ethernet cameras (130a, 130b, 130c . . . ). A graded or progressively reducing primary overcurrent protection of illustratively 5×A, 4×A, 3×A, 2×A and 1×A milli amperes is respectively provided before each of the nodes forming a chain of protections; and activation of any of these protections would disrupt electric power availability to subsequent nodes.

Such disruption is avoided by introducing a faster branched overcurrent protection of illustratively less than 1×A milliamperes in each branch. The graded as well as branched overcurrent protection is in the form of a hard wired fuse or over current protection or an e-fuse.

The present invention recognizes that daisy chain, like any serial chain, simplest being a serial mechanical chain of links, is as strong as the weakest list. Daisy chain of the present invention addresses several electrical and electromechanical serial links, to be able to fully exploit the cost advantages associated with serially connected ethernet cameras. In the preferred embodiment, following one or more of the following is incorporated:
A closed loop signal feedback keeping a watch on mechanical engagement of serial connectors. Any loose connections would cause a change in the closed loop signal.
A path impedance feedback keeping a watch on mechanical engagement of serial connectors. An unusual change in path impedance would imply mechanical weakness/rupture. The path impedance is measured and detected between a plurality of pairs of individual cameras, that is, between a first ethernet camera (130a) and a second ethernet camera (130b), between the second ethernet camera (130b) and the third ethernet camera (130c), and so on. The path impedance is measured and detected by either or by both cameras, by injecting a test signal.

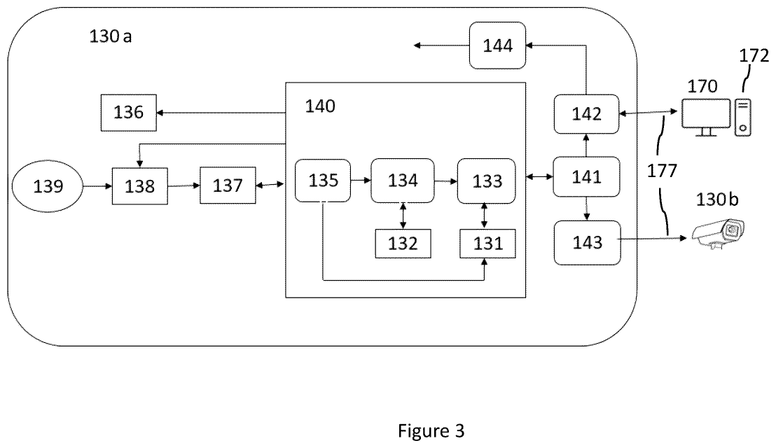

FIG. 3, each ethernet camera (130) comprises at least two ethernet ports—termed a first ethernet port (142) and a second ethernet port (143), and an interconnection switch (141). The ethernet camera is equipped with an infra-red light (136) source preferably a light emitting diode, abbreviated as IR LED (136), along with an infra-red cut filter (138), facilitating a lens (139) and an image sensor (137) to capture images or videos. A “Power on Ethernet” (PoE) module (144) is provided. As a variation, the IR LED (136) is external to the ethernet camera (130). An Image Signal Processors (ISP) (135) and a compression unit (133) and a neural processing engine (NPU) (134) are hardware components of each ethernet camera (130) executing the corresponding software residing therein. The ISP (135) is responsible for processing raw image data captured by the camera's image sensor (137). It handles tasks such as colour correction, noise reduction, exposure control (220), and image sharpening. The ISP (135) ensures that the image quality is optimized before it is encoded and transmitted.

Ethernet cameras (130) deployable in the present invention are EdgeECAM50_USB—AI Smart USB camera, SmarteCAM-IP66 Smart camera with camera/image sensor of different varieties, illustratively Sony IMX335 camera sensor; and such equivalent cameras.

The interconnection switch (141) connects the second ethernet port (143) of each camera (130) to its first ethernet port (142). Based on an address bit scripted thereon, a control communication packet from the system controller (170) received at the first camera (130a) first ethernet port (142) is selectively distributed by its interconnection switch (141) to either the RTSP server (131) of the first camera (130a), or passed on via second ethernet port (143) of the first camera (130a) to the second camera (130b). The control communication packet from the system controller (170) thus received at the second camera (130b) first ethernet port (142) is selectively distributed by its interconnection switch (141) to either the RTSP server (131) of the second camera (130a), or passed on via second ethernet port (143) of the second camera (130a) to the third camera (130c). And so on.

A notification communication and an image data sent from the at least second camera (130b) first ethernet port (142) is delivered to the system controller (170) via the first camera (130a) second ethernet port (143) and corresponding first camera interconnection switch (141).

In a preferred embodiment, Ethernet Switch LAN9354, which is a 3-Port 10/100 Managed Ethernet Switch with Single RMII is provided as the interconnection switch (141), with following port configuration:
Port 0: RMII PHY, RMII MAC modes
Port 1: Internal PHY
Port 2: Internal PHY
2 internal 10/100 PHYs with HP Auto-MDIX support

Each ethernet camera (130) transmits a captured video data from its first ethernet port (142) to the second ethernet port (143) of next Ethernet camera in the serial connection towards the server PC (170), until the video data reaches the server PC (170) through in-between interconnection switch (141) of each ethernet camera (130), consequently the first ethernet port (142) of each camera (130) transmits its own video feed and also forwards the video data from previous cameras to the server PC (170), wherein the closer to the server PC (170) the ethernet camera (130) is, the more video data its first ethernet port (142), its second ethernet port (143) and its interconnection switch (141) handles, as it transmits its own video data as well as the video data of all preceding ethernet cameras.

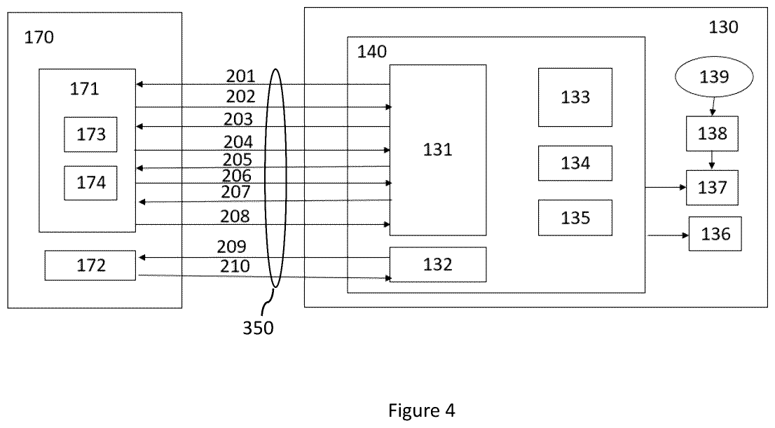

FIG. 4, a system computer program (171) resides in a non-volatile memory of the server (172) of the server PC (170), and communicates with a camera computer program (131) that resides in a camera memory. The system computer program (171) is configured to send via the daisy chain (177) the following signals:
Requisition a prevailing bit rate from each of the ethernet camera of the plurality of connected ethernet cameras, (201)
Send an acknowledgement of the receipt of the prevailing bitrate to each of the ethernet cameras of the plurality of connected ethernet cameras, (202)
Set dynamically an updated and balanced bit rate of each of the ethernet cameras of the plurality of connected ethernet cameras, (203).
Receive dynamically the updated and balanced bit rate of each of the ethernet camera of the plurality of connected ethernet cameras, (204).
Receive a motion detection notification and or a priority frames detection notification from any of the plurality of ethernet cameras, (205).
Send acknowledgement of a corresponding motion detection notification and or priority frames detection notification, (206).
Register day and night mode change of any or each ethernet cameras. (207).
Acknowledge day and night mode change of corresponding ethernet cameras (208)

FIG. 5, each to and fro communication including RTSP video data (209), RTSP commands (210) from/to server PC (170) to/from ethernet camera (130) is on daisy chained network (177) through the physical ethernet cable (350) and provided with a corresponding address bit for appropriate delivery and receipt. Effectively, a direct logical connection happens from server PC (170) to each ethernet camera (130a, 130b, . . . ), therefore the RTSP setup commands are sent directly to each camera from server PC (170) and not through camera to camera, though electronically the commands and data moves between ethernet ports (142, 143) through respective interconnection switches (141).

In the daisy-chained camera network (177) as per present invention, each control message includes a checksum, which is calculated and appended before transmission. Upon receiving the control message, the receiver verifies the checksum to ensure data integrity and detect any errors that may have occurred during transmission. This mechanism enhances the reliability and robustness of the communication process within the network. The system computer program (171) periodically broadcasts a specific, one-to-one control messages to all connected ethernet cameras (130a, 130b, 130c, . . . ) to monitor their status. Each healthy or operational ethernet camera (130) is expected to respond to the broadcast within a predefined timeout period by the system computer program (171). If any ethernet camera (130) fails to respond, it indicates a potential issue with that specific camera. The host (170) identifies the problematic camera based on the lack of response and promptly notifies the user, enabling quick detection and resolution of any issues.

The Image signal processor (ISP) (135) of each of the Ethernet camera (130), besides converting each image or frame from its raw form to a usable form with correction of usability parameters including colour, contrast, brightness, gain and exposure, day and night detection; carries out an important functions of detection of motion. Scenes with detected motion are captured by Ethernet camera (130) with higher number of frames per unit time, requiring higher bitrate to communicate the video. All ethernet cameras (130) in the series connection collectively have an upper limit of availability of bitrate.

The ISP (135) as per present invention detects rate of change of motion as acceleration and as deceleration, sudden start and stop of motion. A neural processing engine (134) processes such input of ISP (135) and with the aid of situational machine learnable data ascertains priority images or frames. The neural processing engine (134) of the present invention also ascertains priority images or frames (310) irrespective and independent of detection of motion. This function is further explained with illustration.

A compression unit (133) of each ethernet camera (130a, 130b, 130c, 130d, . . . ) receives instruction directly from the ISP (135) or through neural processing engine (134) to compress a video by dropping insignificant or nearly repeated frames. The compression unit (133) of the present invention also receives instruction directly from the ISP (135) or through neural processing engine (134) to decompress a video and improve the video quality of priority frames, as explained later.

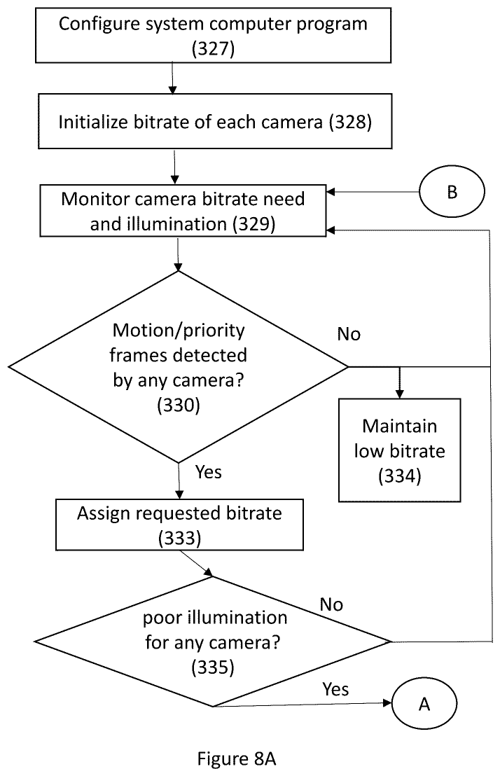

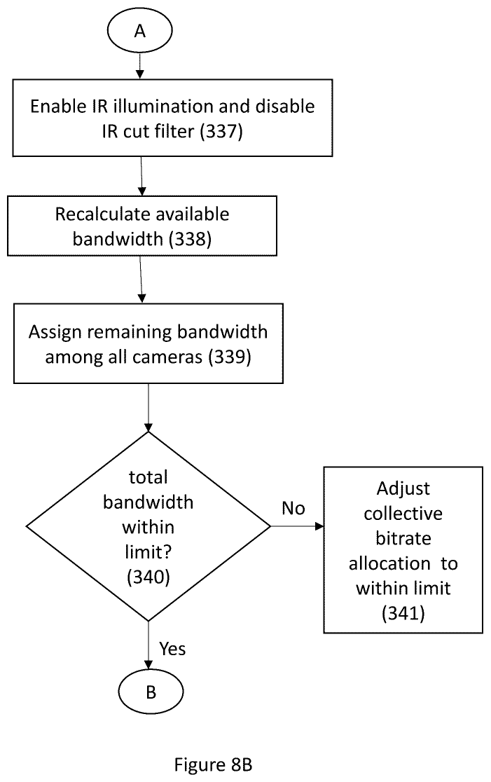

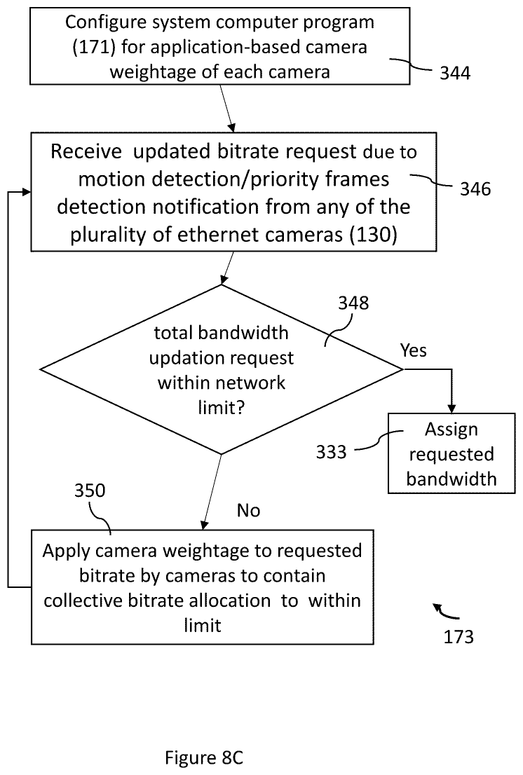

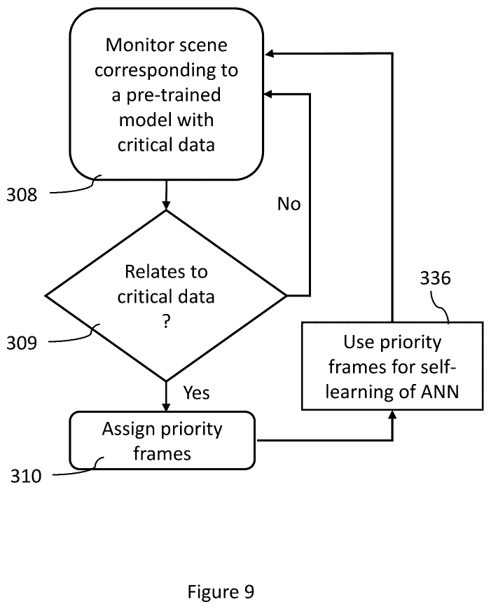

A bitrate manoeuvre subroutine (173) of the system computer program (171) keeps a control on bitrate in use and unused bitrate, and the system computer program (171) communicates weightage based permissible bitrate to respective Ethernet camera (130). The bitrate manoeuvre subroutine (173), based on priority frames ascertainment (310, FIG. 9) by the neural processing engine (134) instructs the prescribed ethernet camera (130) to increase bitrate of static frames, as further elaborated with illustration. FIG. 8C.

Thus, the system of the plurality of ethernet cameras connected in daisy chained network configuration aims at intelligently adjusting the bandwidth allocation for each camera based on real-time priority based scene analysis and motion detection such that each camera efficiently uses the available network bandwidth without causing network congestion and loss of quality.

The present invention recognizes that at times, bitrate requirement of camera may increase for reasons other than due to motion or priority allocation and the invention addresses the reason. One such reason addressed by the present invention is a bit rate rise due to gain rise. Gain is an electronic amplification of video signal. This means that the signal is boosted electronically, to brighten image. The present invention monitors gain of each camera along with its bitrate. The gain and bitrate change in a definite relation is inferred as consequent to reasons other than motion or prioritization.

Particularly, a gain and bitrate change in the definite relation triggers a check of day or night change or change in lighting conditions. The system enables an infra-red (IR) light (136) illumination and a simultaneous deactivation of IR cut filter (138). The net bitrate rise still found is only accounted for and used in bitrate re-allocation.

The preferred embodiment of the present invention envisages an IR light emitting diode (136) integral to the ethernet camera, however IR light can also be external to the camera and of requisite intensity.

The architecture (100, FIG. 1) involves multiple Ethernet cameras (130a, 130b, 130c, . . . 130n) connected in a daisy-chained network (177), with the entire network of cameras further connected to a system server (172) associated with the server PC (170). In a daisy-chained network, each camera is connected to the next in a linear sequence. The first camera (130a) in the chain is connected directly to the network or server PC (170), and each subsequent camera is connected to the previous one. This forms a chain-like structure, where data from each camera is passed along the chain until it reaches the server PC (170).

FIG. 1, 5, when any camera (130) captures video data, it transmits this data to the next camera in the chain towards the server PC (170). This process continues until the data sequentially reaches the server PC (170) through the third, second, first camera respectively. Each camera (130) in the chain not only captures and transmits its own digitized video feed but also forwards the data from previous cameras in the chain.

Because the cameras share a common network path, the available bandwidth must be managed carefully. The closer to the server PC (170) a camera is, the more data it has to handle, as it must transmit its own data as well as the data from all preceding cameras.

Such serial connection therefore mandatorily pushes for and makes efficient bandwidth management critical, especially in scenarios with high-resolution video feeds and or with high numbers of cameras.

In a daisy-chain camera system (100) that necessitates multiplexing and packetizing multimedia transport streams, a Real-Time Streaming Protocol (RTSP) is deployed which enables real-time video transmission from a network of serially connected cameras by setting up and controlling the data stream between the plurality of cameras (130) and server PC (170). RTSP issues commands to establish a streaming session between the server PC and the plurality of daisy-chained cameras. The server PC (170) sends an RTSP SETUP command to initiate the session with a first connected camera (130a). The SETUP command designates the type of media stream, transport protocol, and network ports for data. Importantly, the transmission of streaming data itself is not a task of RTSP. Most RTSP servers (132) use the Real-time Transport Protocol (RTP) in conjunction with Real-time Control Protocol (RTCP) for media stream delivery. As a variation, proprietary transport protocols may be deployed. The RTSP server (132) software from RealNetworks™, for example, also uses RealNetworks' proprietary Real Data Transport (RDT).

Further cameras then receive commands in sequence as the control data moves from ethernet port two (143) of the first ethernet camera (130a) through the interconnection switch (141) of the first ethernet camera (130a) to ethernet port one (142) of the next camera (130b) through the interconnection switch (141) of the next camera (130b) in a definite though infinitesimally small time, and so on; with each camera likewise configured to forward streams to the camera closer to the server PC (170) and eventually to the server PC (170), creating a controlled daisy-chain stream. Once the system is set up, RTSP initiates RTP streams to transmit video packets from each camera in the chain. RTP handles the real-time transport of video data, breaking it into packets and managing timing to synchronize video and audio.

Each camera is equipped with a camera controller or microcontroller generally known as a “system on chip”, also known as SoC (140). The preferred embodiment deploys Eyenix 6-series EN675, The SoC (140) also hosts camera RTSP server (132) functionally termed network interface controller (132) as, enabling live video streaming, session control, and efficient data relay, streaming its video feed to a camera closer to the server PC (170) and eventually to the server PC (170), respond to commands (e.g., SETUP, PLAY, PAUSE, TEARDOWN) of system server (172) of server PC (170).

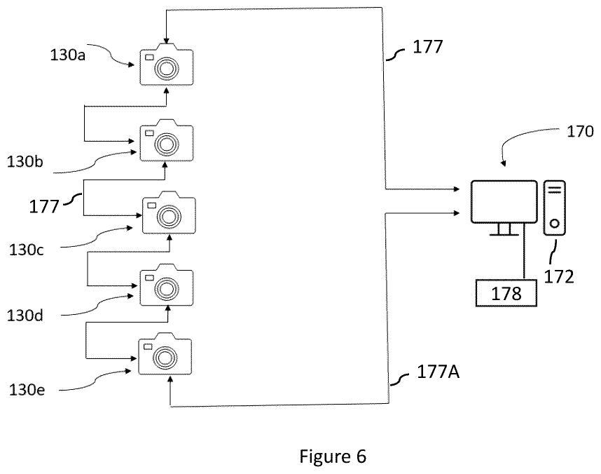

A daisy chain as described above and as shown in FIGS. 1 and 5 has an unused second ethernet port (143) of the farthest camera. In order to add reliability to the daisy chained cameras with the unused second ethernet port, it is prudent to connect the second ethernet port to the server PC and thereby provide an alternate serial connection (177A). FIG. 6.

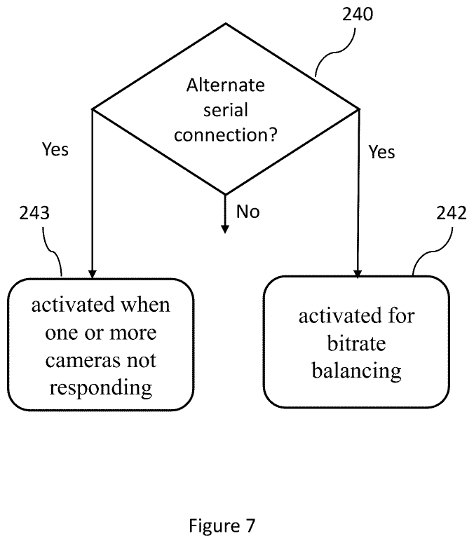

FIG. 7, the alternate serial connection (240) is deployable in several ways, and two such variations are disclosed below.

In a variation, the alternate connection (177A) is activated from the server PC in the event that one or more cameras are detected to be not responding (243).

In another variation, the alternate connection (177A) is activated for bitrate balancing (242) between the serial connection (177) and the alternate connection (177A) by dividing the number of connected ethernet cameras (130a, 130b, 130c, 130d, . . . ) in two prescribed groups based on bitrate history as per application. Illustratively, in a chain of 7 ethernet cameras, cameras 1 to 5 may communicate through a first serial connection (177) and camera 6 and 7 (177A) may communicate through the alternate connection if camera 6 or 7 or both require higher bit rate than camera 1-5.

It is previously summarily discussed that motion results in higher bandwidth requirement from a camera. The present invention also recognizes that more than one or all cameras in a series configuration capture motion of similar order and cumulative bandwidth requirement exceeds pre-decided system bandwidth. Present invention also recognizes that cameras capturing static or low movement frames may also require high quality video with low or no compression and/or high frame rate for analysis and decision making. The NPE (134) of any specific or all ethernet cameras (130) have situation specific pre-trained models to be processed by the artificial neural network (ANN) residing therein. Illustratively, an ethernet camera (130a) of an application specific system monitoring a busy street has a pre-trained model of “face recognition”, another ethernet camera (130b) of the same application specific system may be monitoring a barren road and has a pre-trained model of “suspicious movement”, yet another cameras (130c, 130d) of the same application specific system may not be provided with any pre-trained model!

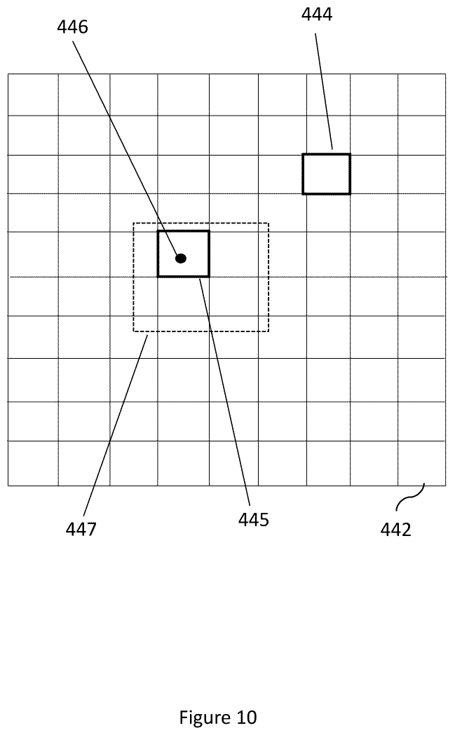

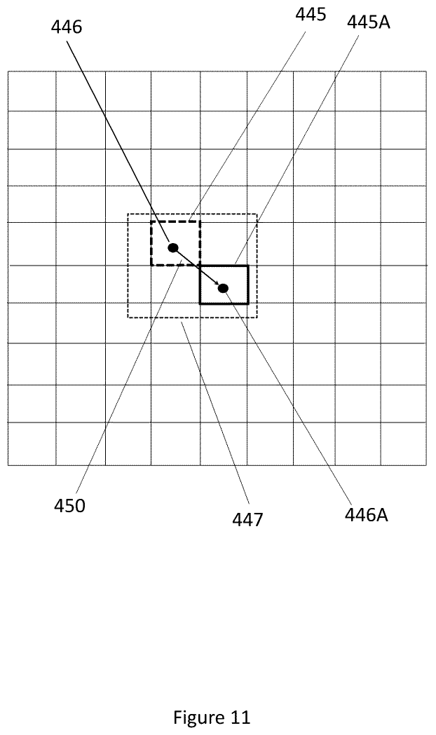

In an embodiment, the ISP (135) identifies an area of interest in each frame based on detection of motion and scene information. FIG. 10, the area of interest (447) around an object position (446) comprises blocks of frame (444, 445) which are smaller, non-overlapping clusters of N×N pixels, for example, 16×16 or 32×32 pixels. These blocks (444) form minimal sample units for motion as well as scene analysis. The preceding or previous frame from the video sequence is also divided into the same block sizes for comparison. Block-based division simplifies the computational problem by limiting motion analysis to manageable regions. For each block in the current frame, the area of interest (447) is defined in the previous frame around the block's original position. FIG. 11, consequent to some motion, a new object position (446A) is detected in another block of frame (445A) in the previous area of interest (447).

The ISP (135) compares current block(s) to blocks in the area of interest (447) in previous frame. The area of interest (447) specifies the region where the matching block is likely to be found, based on expected movement (e.g., a car might move within a 20-pixel radius). The algorithm selects the block with the smallest pixel value difference as the best match, and its displacement generates a motion vector. The size of area of interest is a prescribed and configurable linear equation, illustratively (2W+1)×(2W+1), where W, an area of interest parameter, is maximum expected unit displacement, configured specific to application. For example, if W=10, the area of interest is 21×21 pixels, meaning the algorithm searches within approximately 10 pixels in all directions. The area of interest (447) size may be dynamically adjusted based on scene complexity to balance computational cost and accuracy. The ISP (135) dynamically adjusts the area of interest parameter (W) and prioritizes blocks based on the objects identified based on a library of objects for example human faces or vehicles or buildings or other stray objects.

The system server (172) may store video data locally on hard drives or network-attached storage (NAS) (178) devices, or it could send the data to cloud storage for long-term archiving.

For each block (444) in the current frame (442), the algorithm searches for the best-matched block within the area of interest in the previous frame. The similarity between blocks is quantified using error metrics such as Sum of Absolute Differences (SAD), Mean Squared Error (MSE), etc. The block in previous frame with the lowest error is considered the best match for the current block. The Motion Vector (MV) (450) represents the displacement between the best-matched block in previous frame and the corresponding block in current frame. For each block, compute the magnitude of the motion vector (MV) (450) derived from the difference between the current and previous frames:

$$Magnitude = \sqrt{{( {x}_{c urrent} - {x}_{p r e v} )}^{2} - {( {y}_{c urrent} - {y}_{p r e v} )}^{2}}$$

Here, x_{current}, y_{current}, xₚᵣₑᵥ, yₚᵣₑᵥ are the coordinates of the block in the current and previous frames, respectively. MV represents the displacement of the block.

Cameras can perform onboard analysis of the captured scenes as motion, or critical events e.g. security breaches, based on pre-trained models, when present, of the NPE (134). Only critical video data is streamed in full resolution or at higher priority, while less critical data is forwarded with lower resolution or even dropped if bandwidth is insufficient. When events in specific scenes are not flagged as high-priority by the respective camera (130) based on an absence of the pre-trained model in the corresponding NPE (134), such cameras may send metadata or reduced-quality versions of the feed to lessen bandwidth consumption. This is particularly effective in cases where continuous high-resolution video is unnecessary.

With the Neural Processing Engine (NPE) (134) of any or all cameras (130) of the system (100) provided with an application specific pre-trained model that is, application specific training data, such camera(s) (130) can perform complex video analytics on its own captured video frames locally, including event classification and prioritization besides object detection, motion recognition.

### Example of Source of “Video Analytics”:

Computer Vision Algorithms (e.g., YOLOv8, Faster R-CNN for object detection).
Deep Learning Models (e.g., LSTMs, Transformers for motion prediction).
Edge AI Processors (e.g., NVIDIA Jetson, Intel Movidius for on-device inference).

Instead of sending the full video feed, the camera can transmit only key data summaries, illustratively
Detected objects (e.g., a person, car, or animal),
Event classifications (e.g., “intrusion detected” or “motion in restricted area”),
Timestamps and locations of events, and or
Metadata describing the scene or activity (e.g., “person entered the frame at 3:00 PM”);
or specific event clips, reducing the data load on the network. When events in specific scenes are not flagged as high-priority, cameras may send metadata or reduced-quality versions of the feed to lessen bandwidth consumption. This is particularly effective in cases where continuous high-resolution video is unnecessary.

The neural processing engine (134) provides adaptive thresholds by learning from various environmental factors and motion characteristics. There are various key factors considered for threshold decision such as scene type as indoor, outdoor, crowded, lighting or weather, etc.

ISP (135) with or without machine learning continuously monitors motion vector distributions across blocks. If the magnitude of the motion vector (MV) is less than a predefined threshold, classify the block as static:
If MV Magnitude<Threshold, then Static Region.

Dynamic regions are blocks where significant motion is detected. These areas are often of higher interest for events, objects, or actions

If the magnitude of MV is greater than or equal to the threshold, classify the block as dynamic:
If Magnitude>Threshold, then Dynamic Region.

The artificial neural network (ANN) of the NPE (134) Machine Learning models pre-trained on diverse datasets predict optimal thresholds dynamically:
1. Training dataset which includes samples of frames labelled with static and dynamic regions across different environments.
2. Features for Prediction:

Average motion magnitude in the frame.

Histogram of motion magnitudes across blocks.

Contextual scene features (e.g., crowdedness, presence of moving objects).
3. Model Output: AI predicts a threshold value specific to the current scene.

The ISP (135) with or without machine learning identifies blocks with motion as active or areas of interest. This block-based approach allows for focused monitoring within certain regions, reducing unnecessary data processing for static blocks (areas with no detected motion). If motion is detected in a block, the camera increases the bitrate for that block's data, allowing it to capture and transmit higher-quality details for the moving object or event. Bulk of blocks without detected motion can be transmitted at a lower bitrate.

The compression unit (133) compresses the processed video data into a format that can be efficiently transmitted over the network. H.264 is a widely used video compression standard that reduces the amount of data required to represent video without significantly compromising quality. The present invention is, however, not limited thereto and is configurable with and for different encoding methods including H.265+, H.264+, JPEG, and MJPEG.

The compression unit (133) supports constant bitrate as well as variable bitrate control, allowing it to adjust the bitrate based on the complexity of the scene and the level of motion detected. The bitrate can be increased for high-motion scenes to preserve detail or decreased when the scene is static to save bandwidth. The compression interfaces with both the ISP (for input data) (135) and the network interface controller (132) (for output data).

The ISP (135) in each of the plurality of ethernet cameras (130) analyses the video streams captured by itself. Respective ethernet camera (130a, or 130b, or 130c . . . ) identifies motion within the scenes and distinguishes between significant motion (e.g., a person or vehicle) and irrelevant changes (e.g., shadows or lighting changes). The ISP (135) may utilize dedicated hardware accelerators, such as GPUs or specialized motion detection processors associated with the respective ethernet camera (130a, or 130b, or 130c . . . ), to perform real-time analysis on its own captured video contents or frames.

FIG. 8C, the bitrate manoeuvre sub-routine (173, FIG. 4) is responsible for adjusting the bitrate of each camera's video stream based on the motion and scene analysis results generated by the ISP (135) of the respective cameras (130), and reported to the server PC (170). If significant motion and or priority frames (310) are reported by any ethernet camera (130), the bitrate for that camera is increased to improve image quality. Conversely, if no significant motion or priority frames (310) are detected/reported by any camera, the bitrate of that camera is reduced or maintained low to conserve bandwidth. The bitrate manoeuvre sub-routine (173) makes real-time adjustments by communicating with the respective cameras one-to one, over the daisy chain network (177), instructing their respective compressions unit (133) to modify the output bitrate. The system computer program (171) is configurable to assign a weightage (344) to each ethernet camera (130a, 130b, 130c, 130d, . . . ) present in the system (100). When an updated bitrate request from the respective cameras (130) is received (346) for higher bandwidth, and the cumulative bandwidth request from all cameras (130) is NOT withing the prescribed network limit (348), then the bitrate manoeuvre subroutine (173) distributes available bitrate in accordance to weightage (350), FIG. 8C, in the event of multiple cameras detecting and reporting motion and or priority frames (310) and requisition a bitrate which is collectively higher than a maximum allowable bitrate for the system (100). Based on the pre-trained model of the NPE (134) of any or all cameras (130a, 130b, 130c, 130d, . . . ) of the system (100), the ISP (135) of the corresponding camera (130) predicts and requisitions future bandwidth needs and pre-emptively adjust bitrate settings based on patterns detected in the data, such as peak activity periods or recurring motion events. The server PC (170) continuously monitors all camera streams and dynamically adjusts bitrates as scene conditions change, ensuring optimal network performance and video quality. In absence of configuration by weightage of respective cameras, the bitrate manoeuvre subroutine (173) applies a ratio factor of cumulative bandwidth limit divided by the cumulative bandwidth request to all cameras (130), to keep the cumulative bitrate within the prescribed limit of the daisy chain (177) of the system (100).

The workflow described in FIGS. 8A and 8B outlines a process for dynamically adjusting the bitrate of Ethernet cameras in a daisy-chained network based on scene changes and available bandwidth. All components of the system (100) including the server PC (170) and the associated server (172), and camera network including the ethernet cameras (130), Image Signal Processors (ISP) (135), NPE (134), compression unit (133), are powered on by a “Power on Ethernet” (PoE) Module (144).

The system computer program (171) is configured (327) including assigning application specific weightages to each camera (130a, 130b, 130c, 130d, . . . ), and the ISPs (135) and NPE (134) within each camera (130) are initialized, thus the server PC (170) initializes bitrate for each camera (328), each respective ISP (135) begins processing raw image data from the respective image sensor (137), optimizing it for compression by the respective compression unit (133), for example H.264.

The ISP (135) in each camera continuously monitors the bitrate need and illumination (329) of the internal video feed for changes in the scene or image viewed. Scene changes (330) could include motion, lighting variations, or other relevant visual alterations with reference to the pre-trained application specific model supplied to the NPE (134) of respective camera (130). If motion is detected by the ISP (135) and or if a priority frames are detected and assigned (310) by the ANN of the NPE (134) based on a critical relatable data (309) with respect to the application specific pre-trained model, then the corresponding ISP (135) assesses the increased bitrate requirement and communicates to the server PC (170), and the server PC (170) assigns increased bitrate (333) to the respective camera (130). If no change is detected, the same bitrate is maintained (334) while the system (100) continues monitoring bitrate need and illumination (329).

The respective camera (130) sends data about the scene (e.g., motion level, complexity) to the server PC (170). This data is crucial for the server to make informed decisions about bandwidth allocation—to provide the server PC (170) with the necessary information to analyze overall network bandwidth usage and make adjustments across the entire camera network.

The neural processing engine (134) of each camera (130) continuously receives scene data. The respective NPE (134) predicts potential scene changes based on historical data and environmental factors, making the system more proactive rather than just reactive.

Based on the analysis, the server PC (170) allocates the appropriate amount of bandwidth to each camera (130). Cameras (130) with more complex scenes receive more bandwidth, while others may have their bandwidth reduced to ensure that each camera operates optimally within the available network daisy chain (177) bandwidth, maximizing video quality and minimizing the risk of congestion.

The server PC (170), based on analyses from ISP (135) and neural processing engine (134) allocates bandwidth to each camera (130) based on real-time scene analysis and motion detection respectively. Cameras (130) capturing high-motion scenes receive more bandwidth, while those with static scenes receive less. The bitrate maneuver subroutine (173) of the system computer program (171) prioritizes bandwidth allocation based on the importance of each scene. For example, a camera monitoring a critical area (309) with assigned priority frames (310) might be given more bandwidth even if the scene is static, ensuring that quality is maintained for high-priority locations. Also, the bitrate maneuver subroutine (173) applies weightage configured for each camera (130) for determining importance of scene.

The server PC (170) checks if the total available network bandwidth (340) is sufficient to support the current bitrate settings for all cameras. The server PC (170) continuously monitors the network's bandwidth usage (329) and determines if the current allocation is sustainable. If the bandwidth is sufficient, the server PC (170) maintains the current settings. If not, it triggers corrective actions (341) by the bitrate maneuver subroutine (173) to optimize the usage while the system (100) continues to monitor the scene (308) changes.

The ISP (135) of respective cameras (130) continuously identify static or low-motion scenes and requisition to reduce their bitrate to free up bandwidth for more demanding cameras (130). In some cases, ISP (135) can selectively mask certain areas of a static scene, reducing the bitrate without compromising the quality of critical areas (309) within the same frame and the server PC (170) takes further action to reduce the frame rate/bitrate bandwidth of cameras (130) capturing static scenes by way of configured weightage, to prevent network overload by ensuring that the combined bitrate of all cameras (130) does not exceed the network's capacity or prescribed limit.

If the network is nearing its bandwidth limit, the server PC (170) reduces the bitrate of cameras (130) that are capturing non-critical, static or less complex scenes. This frees up bandwidth for cameras that require it due to high motion or complexity. To optimize the use of available network resources, ensuring that critical scenes are captured in high quality while less important scenes are downscaled to preserve bandwidth.

If there are no changes in bitrate, then the system (100) continues monitoring (329), otherwise after making any necessary adjustments, the system returns to the initial step of monitoring (329) for scene changes, to continuously and dynamically manage the network's bandwidth and camera bitrate, ensuring that the system (100) remains responsive to changes in the environment. The server PC (170) along with ISP (135) of all cameras (130) in the system (100) ensure that the system (100) remains in a loop, constantly monitoring scene changes and adjusting bitrates as needed. Over time, the ANNs of respective NPEs (134) of individual cameras (130) provided with the pre-trained model, learn from the data processed (336, FIG. 9), improving its ability to predict scene changes, allocate bandwidth, and manage bitrate more effectively.

FIGS. 8A, 8B, 8C and 9 outline an intelligent and efficient way to manage video data transmission in a network of cameras (130) of one embodiment of the present invention, using dynamic bitrate adjustments, area of interest (AOI), masking area of non-interest (AONI), and real-time monitoring to ensure optimal use of bandwidth while maintaining video quality.

Once motion is detected, the system (100) including respective ISPs (135) and NPEs (134) of each camera (130) identifies and segregates from the area of NON-INTEREST (AONI) the specific areas of the scene where the relevant motion occurs. These areas are marked as the “area of interest” (AOI). The system focuses on these AOIs for higher quality encoding e.g. lower or no compression, higher frame rate, etc. even if slow moving or static for a “critical area”, while less important parts of the scene receive lower attention. This helps in optimizing the use of bandwidth.

Based on the detected motion and the defined AOIs and AONIs, the system (100) calculates the required bitrate for each camera. Cameras with more complex scenes (309) (e.g., multiple AOIs or high motion) are allocated a higher bitrate. The system adjusts the bitrate in real-time, ensuring that cameras (130) capturing more important or complex scenes (309) have the necessary bandwidth to maintain video quality. AI models predict the optimal bitrate needed for each scene, taking into account factors like motion complexity, scene lighting, and historical data. The ANN of the NPE (134), by progressive self-learning consequent to in-use data updating the pre-trained data, can also preemptively adjust bitrates if it anticipates changes in the scene.

The system computer program (171) recalculates the available bandwidth (338) periodically, after
Requisitioning a prevailing bit rate from each of the ethernet camera of the plurality of connected ethernet cameras, (201),
Sending an acknowledgement of the receipt of the prevailing bitrate to each of the ethernet cameras of the plurality of connected ethernet cameras, (202),
Setting dynamically an updated and balanced bit rate of each of the ethernet cameras of the plurality of connected ethernet cameras, (203), and
Receiving dynamically the updated and balanced bit rate of each of the ethernet camera of the plurality of connected ethernet cameras, (204).

If there's insufficient network daisy chain (177) bandwidth, the system redistributes the bitrate (339, FIG. 8B) among the cameras. It reduces the bitrate for cameras with static or less important scenes to free up bandwidth for those with significant motion or critical AOIs (309). The system ensures that the overall network remains balanced, with no single camera consuming an excessive amount of bandwidth. Machine learning algorithms of NPE (134) optimize this redistribution by analyzing which cameras can afford a reduction in bitrate without compromising essential video quality. The NPE (134) can also suggest alternative strategies, such as temporarily lowering the resolution or frame rate.

With the bitrate adjusted and optimized, the cameras transmit the video data to the server PC (170). The server PC (170) continuously monitors the quality of the transmitted video, detecting any potential issues (like packet loss or jitter) and making real-time adjustments to mitigate them. The process reaches its endpoint, either after a predetermined period or when the system is shut down. The system can also reinitialize for another round of monitoring and adjustment if required.

By assessing illumination, the system computer program (171) checks whether the gain level in any camera has increased (335, FIG. 8A). An increase in gain typically happens when the lighting conditions worsen, such as during night-time or in poorly lit areas. When the gain increases implied from poor illumination (335), the system computer program (171) or ISP (135) enables Infrared (IR) (136) illumination and deactivates the IR cut filter (138) in the affected cameras. This adjustment helps to improve image quality in low-light conditions without unnecessarily increasing the bitrate. If no gain increase is detected, the system continues to monitor the bitrate and gain levels (329) of each camera, ensuring that they remain optimal for the current scene conditions.

Implementing infrared (IR) (136) illumination (337) and disabling the IR cut filter (138) switch allows IR light to enter the image sensor (137). IR illumination helps to reduce noise in low-light conditions, thereby providing clearer images without requiring an increase in bitrate. This ensures efficient use of bandwidth by transmitting higher quality images without unnecessary increments.

This approach helps manage bandwidth more effectively, especially in challenging low-light scenarios where noise can otherwise lead to inefficient bitrate and bandwidth usage. The number of cameras (130) that can be connected in a daisy chain network depends on the available bandwidth and power consumption of each camera.

This dynamic adjustment ensures optimal use of the available bandwidth, maintaining high image quality where needed while balancing the overall network load.

When all the cameras in the network are capturing scenes with significant motion or changes or critical areas simultaneously, the system must allocate bandwidth equally across all cameras. This scenario can occur, for example, in an application where multiple cameras are monitoring different areas of a high-activity environment (e.g., a busy factory floor or a crowded event)

Because the system (100) has to share the available daisy chain (177) bandwidth among all cameras (130), each camera may receive a lower bitrate than it would if only one or a few cameras were detecting motion. This compromise means that while all cameras can continue capturing video, the quality may be reduced because the available bandwidth must be divided equally. This can lead to a scenario where no single camera can capture a particularly high-quality image, as all cameras are limited by the shared bandwidth. This is a trade-off between ensuring continuous coverage and maintaining the highest possible overall image quality.

As a variation, an upper prescribed limit for identified cameras is higher than remaining cameras. As a further variation, based on application, there are graded upper and lower prescribed bitrate limits. Illustratively, for a system with 100 MBPS as collective prescribed limit, the graded prescribed limits are:

| Camera Number | Upper prescribed limit | Lower prescribed limit |
|---|---|---|
| 1 | 80 MBPS | 40 MBPS |
| 2 | 70 MBPS | 30 MBPS |
| 3 | 60 MBPS | 20 MBPS |
| 4 | 50 MBPS | 10 MBPS |
| 5 | 40 MBPS | 10 MBPS |

Following illustrative situations further explain the analysis with respect to motion and scene.

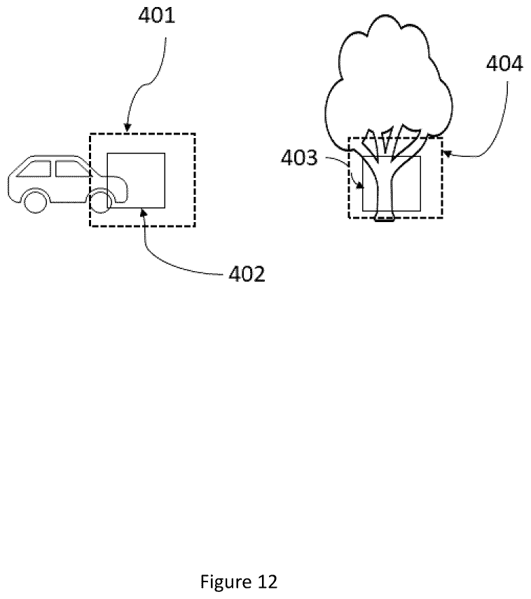

FIG. 12-15, a tree and a moving car are captured by one of the ethernet cameras (130) of the system as per present invention, wherein at least one defined motion area of interest (401) of the moving car and at least one static area of interest (404) of the tree become constituents of analysis and bandwidth moderation of the video captured by the ethernet camera. The area of interest (401) segregates a moving object from a static object based on a magnitude and direction of a motion vector and its rate of change in subsequent frames.

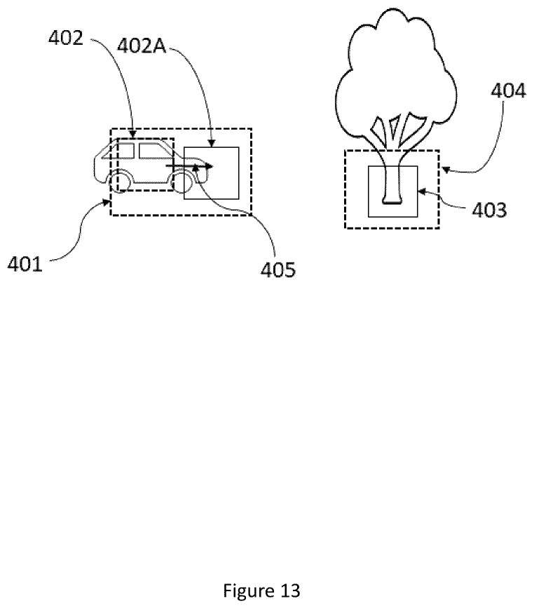

FIG. 13, by comparing blocks (402) and (402A) of adjacent frames, a non-zero motion vector (405) is generated by the ISP (135), while no motion is inferred by comparing blocks (403) of adjacent frames. Consequent to the non-zero motion vector (405), the ethernet camera (130) captures the car as a moving object, passing by the tree. In case a summation of required bandwidth of the system is lesser than a prescribed bandwidth of the system, the compression unit (133) of the ethernet camera (130) encodes the video of such frames without any compression instructions from the ISP (135) and video output is of unaltered quality of the scene viewed by the ethernet camera (130).

In case the summation of the required network (177) bandwidth of the system (100) is nearing or exceeding the prescribed bandwidth of the system (100) the server PC (170) instructs the ISP (135)/NPE (134) to assess the motion area of interest (402) of the car with reference to a library of objects and if any frame is captured with a classified information, for example, registration number of the car then such AOI frames are uncompressed or improved further while a remaining motion area of interest is compressed to bring the summation within the prescribed bandwidth of the system.

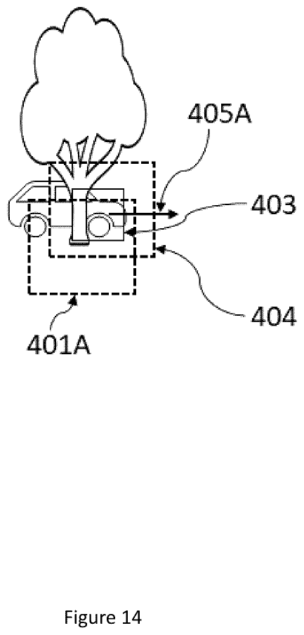

FIG. 14, when the car is passing behind the tree, comparison of motion vector (405A) with respect to the earlier motion vector (405) of adjacent frames and or overlapping areas of interest (401A, 404) infers partial occlusion and acted upon according to further analysis. A longer occlusion is tagged as critical data (309) and the frame quality is improved or uncompressed, while a short occlusion is ignored.

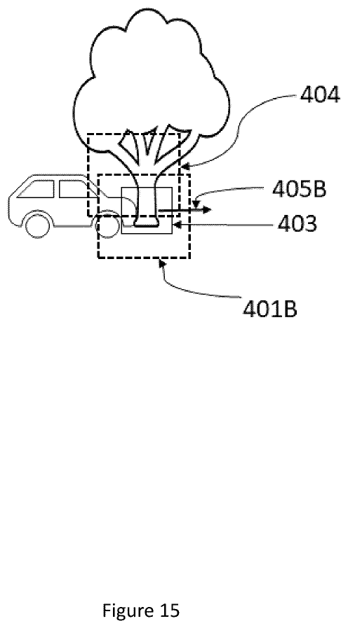

FIG. 15, in case of the car hitting the tree and coming to an abrupt stop, a magnitude of the motion vector (405B) drops suddenly to near zero. Even though motion=0, the collision generates sudden changes in pixel values due to debris scattering, deformation of the car or tree, alterations in lighting including sparks or reflections) etc., creating high difference scores in blocks near the collision. The abrupt reduction in motion vectors and sudden high difference scores (calculated by comparing pixel values between consecutive frames) indicate such impact event as “critical data” (309) and thus assigned priority frames (310). The overlapping area of interest (401B) with the tree's static area of interest (404) substantiates the inference. The blocks representing the car, the tree, and the immediate surrounding area are classified as the dynamic region due to significant pixel-level changes. The system (100) classifies this region for analysis, and is given priority (310) for bitrate allocation to be able to subsequently identifying the cause of the collision or assessing damage.

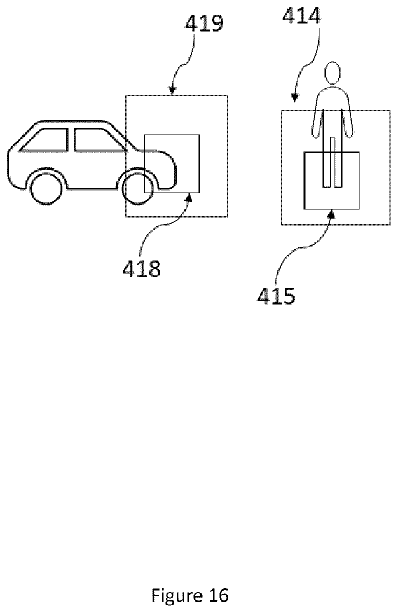

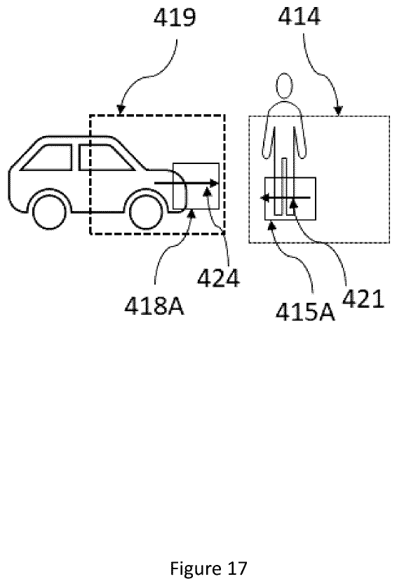

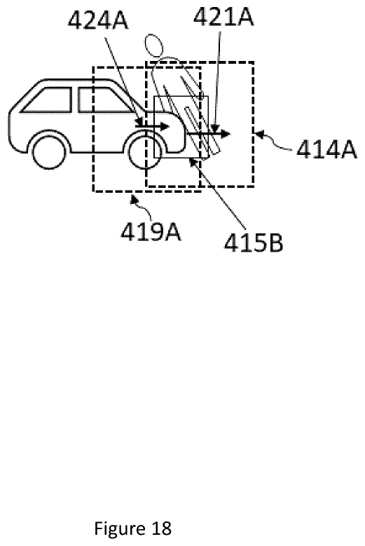

FIG. 16-18, in situation of the car approaching a person in a significantly decelerating manner and or motion block (418, 418A) of the car and static block (415, 415A) of the person are significantly the same block (415B) and or an area of interest of the person (414, 414A) and the car (419, 419A) overlap rapidly, then the present invention infers or calculates such situation as a priority/classified situation (310) and the corresponding ethernet camera is enabled to capture the scene at higher frame rate/bitrate.

A motion vector of the person (421, 421A) may be in the same or in the opposite direction to the motion vector of the car (424, 424A). Reversal of motion vector of the person and a magnitude of the motion vector of the person becoming identical to that of the car may forecast or imply a clear hit or hit & drag case!

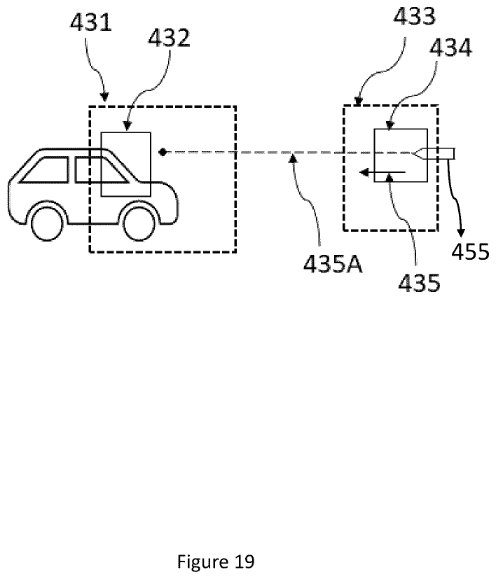

FIG. 19, in a situation of any object illustratively a bullet (455) or a stone approaching the car at a significantly higher velocity, such that motion blocks (432, 434) and area of interest (431, 433) overlap rapidly, then such situation is inferred as a classified or priority situation (310) and the corresponding ethernet camera captures the scene at a higher frame rate and or low data compression.

The neural processing engine (135) is configured to execute a predictive analysis based on the ISP (134) detecting the rate of change of motion as acceleration and as deceleration, sudden start and stop of motion. Motion vector magnitude and direction is manipulated to generate a trajectory of the moving object. The neural processing engine (134) processes such input of ISP (135) and with the aid of situational or application specific discretized machine learnable data ascertains priority images or frames (310). The neural processing engine (134) of the present invention while ascertaining priority images or frames predicts frames not yet captured by the daisy chained ethernet cameras (130). Thus, in above described illustrative situations of long occlusion, significant deceleration, direction reversal of motion vector, the server PC (170) generates a warning signal and alerts for onward transmission to aid preventive and destructive likely event. Such predictive and preventive warning signals and alerts are illustratively sent to an organized emergency data of the neural processing engine.

In the current illustration, the preventive warning signal and alert may be communicated to (a) driver of another vehicle behind the decelerating car to either change lane or likewise decelerate, (b) microcontroller of car of another vehicle behind the decelerating car to either change line or likewise decelerate (c) police control room to proactively keep a watch on scene of significant deceleration.

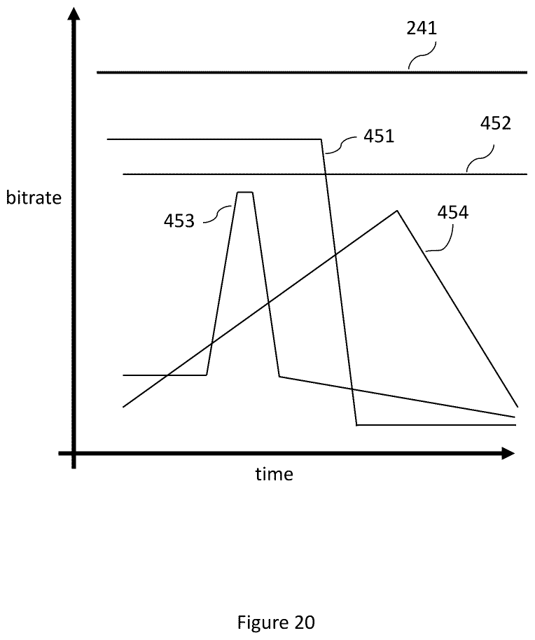

FIG. 20, illustratively for a system with a prescribed bitrate (241), each illustrative motion situation have divergent implications.

A rapidly decelerating motion situation (451) wherein a sudden fall in motion is detected would imply reduction in bitrate permissibility from only a motion perspective, and would imply a priority situation (310) indicating a crash, implying a maintained high bitrate or increased bitrate to be able to better analyse the scene! Further if the decelerating motion again would have changed to an accelerating motion situation, then it might imply a crash avoidance situation.

A consistently high motion situation (452) may imply a normal situation, not necessitating higher bitrate.

A transiently peaking motion situation (453) may imply a criminal or activity of a sudden damage and may imply a high bitrate even after the high motion situation vanishes!

A gradual accelerated motion detection followed by a gradual decelerating motion detection (454) may imply a normal situation not necessitating higher bitrate.

Such divergent implications are addressed by an application specific configuration wherein each system of daisy chained ethernet cameras (130) is configured according to the history of the application and then the neural processing engine (134) inputted with such data reviews motion interpretation by ISP (135), particularly wherein a mere motion based manipulation of the bitrate does not lead to acceptable summation of asked individual bitrate.

Summarily, the system computer program (171) residing in the microcontroller based computing device and a camera computer program (131) residing in each of the plurality of ethernet cameras (130) execute a dynamic bitrate configuration, comprising the steps of:
switching on an electric power to the plurality of ethernet camera in the series configuration, by the system computer program (171)
setting an upper bitrate and a lower bitrate of each ethernet camera, by the system computer program (171)
detecting motion in an area of interest of respective ethernet cameras, by the camera computer program (131)
detecting a priority situation with respect to a library of situations and a training data, by the camera computer program (131)
changing permissible bitrate of each camera in direct accordance with motion detection provided a collective bitrate is within a prescribed bitrate limit
switching on infra-red illumination (337) and disabling infra-red cut filter to bring the collective bitrate withing a prescribed limit, by the camera computer program (131) or the system computer program (171)
changing permissible bitrate of each camera in direct accordance with priority detection provided a collective bitrate is within a prescribed limit, by the system computer program

In very brief, all compression and processing including AI/ML happens within individual cameras (130), and different cameras DO NOT influence one another in bitrate management. Each camera (130) only reports the information and responds to queries by the server PC (170). Inter-camera balancing is done by server PC (170).

The present invention, therefore, dynamically manages bitrate configuration in daisy chained ethernet cameras (130) based on motion, illumination and priority classification (310), such that video frames of each ethernet camera (130) are of higher intellect value than just visual contents with minimum or optimum bitrate.

The terms ethernet camera and camera are used interchangeably.

1. A system of distributed cameras, comprising:
a first camera having a first Ethernet port, a second Ethernet port, an interconnection switch, an image signal processor, a compression unit, a neural processing engine, and a camera controller capable of providing an image data stream having a selectable data bit rate to at least one of said first Ethernet port and said second Ethernet port;
at least a second camera having a first Ethernet port, a second Ethernet port, an interconnection switch, an image signal processor, a compression unit, a neural processing engine, and a camera controller capable of providing an image data stream having a selectable data bit rate to at least one of said first Ethernet port and said second Ethernet port;
a daisy chain Ethernet connection connecting said first camera second Ethernet port to said at least second camera first Ethernet port;
a system controller connected to said first camera first Ethernet port by said daisy chain Ethernet connection to receive said image data stream from said first camera and said at least second camera at a bit rate according to the first camera selectable data bit rate and the at least second camera selectable data bit rate, wherein
a control communication packet from the system controller received at the first camera first ethernet port is selectably distributed to respective cameras by the first camera interconnection switch, and to the at least second camera interconnection switch,
a notification communication and an image data sent from the at least second camera first ethernet port is delivered to the system controller via the first camera second ethernet port and corresponding first camera interconnection switch,
the selectable data bit rate of said first camera and the selectable bit rate of said at least second camera are each selectable according to a corresponding first camera image and at least a second camera image, and
the system comprises a bandwidth having a maximum data bit rate, and said first camera image data bit rate and said at least second camera data bit stream are selected based on priority, motion, situation, illumination of video frames, to avoid exceeding the system maximum data bit rate.

1. The system of distributed cameras as claimed in claim 1, wherein a control communication protocol sends and receives the control communication packet to and from the farthest camera from the system controller in the daisy chain ethernet connection as the first packet within each communication cycle.

2. The system of distributed cameras as claimed in claim 2, wherein the control communication packet includes a specific checksum.

3. The system of distributed cameras as claimed in claim 1, wherein the system computer program periodically broadcasts a specific one-to-one check message for each connected camera, wherein each operational camera responds to the one-to-one check message within a predefined timeout period.

4. The system of distributed cameras as claimed in claim 1, wherein a graded primary overcurrent protection is respectively provided before each of the cameras forming a chain of protections while a branched overcurrent protection of a reduced electric current rating provided in each branch of respective camera.

5. The system of distributed cameras as claimed in claim 1, wherein the system computer program provides a closed loop signal feedback through a plurality of mechanically engaged connectors in the daisy chain ethernet connection.

6. The system of distributed cameras as claimed in claim 1, wherein the system computer program provides a path impedance feedback through a plurality of mechanically engaged connectors in the daisy chain ethernet connection.

7. The system of distributed cameras as claimed in claim 1, wherein the system computer program is configured to:
requisitioning a prevailing bit rate from each of the camera of the plurality of connected cameras,
sending an acknowledgement of the receipt of the prevailing bitrate to each of the cameras of the plurality of connected cameras,
setting dynamically an updated and balanced bit rate of each of the cameras of the plurality of connected cameras,
receiving dynamically the updated and balanced bit rate of each of the camera of the plurality of connected cameras,
receiving a motion detection and or a priority notification from any of the plurality of cameras,
sending acknowledgement of a corresponding motion/priority notification,
register day and night mode change of any or each cameras, and
acknowledge day and night mode change of corresponding cameras,
each to and fro communication from system controller to respective cameras is on daisy chain ethernet connection.

8. The system of distributed cameras as claimed in claim 1, wherein the second ethernet port of the camera farthest from the system controller is connected to the system controller forming an alternate serial connection.

9. The system of distributed cameras as claimed in claim 9, wherein the alternate serial connection is activated by the system controller in the event that one or more cameras are detected to be not responding.

10. The system of distributed cameras as claimed in claim 9, wherein the alternate serial connection is activated for bitrate balancing by dividing the number of connected cameras in two prescribed groups based on bitrate history as per application.

11. The system of distributed cameras as claimed in claim 1, wherein each camera is pre-configured for an upper prescribed limit and a lower prescribed limit of permissible bit rate by an application specific configuration according to a previous trend of the application in each location of the camera disposed.

12. The system of distributed cameras as claimed in claim 1, wherein the neural processing engine has an artificial neural network having a pre-trained application specific model.

13. The system of distributed cameras as claimed in claim 13, wherein the neural processing engine of each camera is inputted with scene and motion video data by the image signalling processor of the corresponding camera for priority classification with respect to the pre-trained application specific model.

14. The system of distributed cameras as claimed in claim 13, wherein the neural processing engine of each camera is inputted with scene and motion video data by the image signalling processor of the corresponding camera for a predictive analysis and prediction of potential increase in required bitrate.

15. The system of distributed cameras as claimed in claim 13, wherein the neural processing engine of each camera is inputted with scene and motion video data by the image signalling processor of the corresponding camera for a self-learning of the artificial neural network of the neural processing engine.

16. The system of distributed cameras as claimed in claim 1, wherein each camera requesting an increased bitrate consequent to a gain and bitrate change in the definite relation triggers a check of day or night change or change in lighting conditions, the system computer program enables an infra-red (IR) light illumination and a simultaneous deactivation of IR cut filter, wherein the net bitrate rise still found is only accounted for and used in bitrate re-allocation.

17. The system of distributed cameras as claimed in claim 1, wherein each camera transmits a captured video data from its first Ethernet port to the second ethernet port of next camera in the daisy chain Ethernet connection towards the system controller, until the video data reaches the system controller through in-between interconnection switch of each camera, consequently the first ethernet port of each camera transmits its own video feed and also forwards the video data from previous cameras to the system controller, wherein the closer to the system controller the camera is, the more video data its first ethernet port, its second ethernet port and its interconnection switch handles, as it transmits its own video data as well as the video data of all preceding cameras.

18. The system of distributed cameras as claimed in claim 1, wherein the image signal processor is configured to identify an area of interest in each frame divided into blocks of prescribed number of pixels, wherein the area of interest is based on motion detection and or scene information.

19. The system of distributed cameras as claimed in claim 18, wherein the area of interest segregates a moving object from a static object based on a magnitude and direction of a motion vector and its rate of change in subsequent frames.

20. The system of distributed cameras as claimed in claim 1, wherein the image signal processor is configured to identify an area of non-interest.

21. The system of distributed cameras as claimed in claim 1, wherein the neural processing engine predicts bandwidth needs based on pattern of historical data including peak activity periods and recurring motion events.

22. The system of distributed cameras as claimed in claim 1, wherein the real-time assessment of priority is ascertained by the ISP by comparison of area of interest with a library of situations.

23. The system of distributed cameras as claimed in claim 1, wherein the real-time assessment of priority is ascertained by the neural processing engine with training data and machine learning.

24. The system of distributed cameras as claimed in claim 1, wherein the system controller is configured for a weightage of distributed cameras.

25. The system of distributed cameras as claimed in claim 1, wherein the system computer program residing in the microcontroller based computing device and a camera computer program residing in each of the plurality of cameras execute a dynamic bitrate configuration, comprising the steps of:
a. starting an electric power supply and a control communication to the distributed cameras in the daisy chain ethernet connection,
b. setting an upper bitrate and a lower bitrate of each camera,
c. detecting motion in an area of interest of video frames of respective cameras,
d. detecting a priority situation with respect to a library of situations and a training data,
e. changing permissible bitrate of each camera in direct accordance with motion detection provided a collective bitrate is within a prescribed bitrate limit,
f. switching on infra-red illumination and disabling infra-red cut filter to bring the collective bitrate withing a prescribed limit,
g. changing permissible bitrate of each camera in direct accordance with priority detection provided a collective bitrate is within the prescribed limit, and
h. changing permissible bitrate of distributed cameras in accordance with a configured application specific weightage keeping the collective bitrate within the prescribed limit.
